(19) United States
(12) Patent Application Publication
(10) Pub. No.: US 2023/0413104 A1
(43) Pub. Date: Dec. 21, 2023

(54) SIGNALING FOR FRAME RATE AND/OR BIT RATE INDICATION AND INQUIRY RELATED TO TRAFFIC WITH A HIGH DATA RATE

(71) Applicant: QUALCOMM Incorporated, San Diego, CA (US)

(72) Inventors: Linhai HE, San Diego, CA (US); Yuchul KIM, San Diego, CA (US); Huilin XU, Temecula, CA (US)

(21) Appl. No.: 18/316,095

(22) Filed: May 11, 2023

Related U.S. Application Data
(60) Provisional application No. 63/365,179, filed on May 23, 2022.
(60) Provisional application No. 63/370,924, filed on Aug. 9, 2022.

(51) Int. Cl. H04W 28/02; H04W 28/18

(52) U.S. Cl. CPC H04W 28/0268; H04W 28/18; H04W 28/0257

(57) ABSTRACT

Various aspects of the present disclosure generally relate to wireless communication. In some aspects, a user equipment (UE) and a network entity may communicate to signal information related to an estimated available bit rate (ABR) for each of one or more logical channels on at least one of an uplink or a downlink. The UE and the network entity may communicate traffic associated with the one or more logical channels according to a frame rate or a bit rate that is based at least in part on the information related to the estimated ABR for the one or more logical channels. Numerous other aspects are described.

### CROSS-REFERENCE TO RELATED APPLICATION

This Patent application claims priority to U.S. Provisional Patent Application No. 63/365,179, filed on May 23, 2022, entitled “SIGNALING FOR FRAME RATE AND/OR BIT RATE INDICATION AND INQUIRY RELATED TO TRAFFIC WITH A HIGH DATA RATE,” and to U.S. Provisional Patent Application No. 63/370,924, filed on Aug. 9, 2022, entitled “ADAPTATION OF UE CONFIGURATIONS,” and assigned to the assignee hereof. The disclosures of the prior Applications are considered part of and are incorporated by reference into this Patent Application.

### FIELD OF THE DISCLOSURE

Aspects of the present disclosure generally relate to wireless communication and to techniques and apparatuses associated with signaling for frame rate and/or bit rate indication and inquiry related to traffic with a high data rate.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to communicate with a network entity to signal information related to an estimated available bit rate (ABR) for each of one or more logical channels on at least one of an uplink or a downlink. The one or more processors may be configured to communicate traffic associated with the one or more logical channels according to a frame rate or a bit rate that is based at least in part on the information related to the estimated ABR for the one or more logical channels.

Some aspects described herein relate to a network entity for wireless communication. The network entity may include a memory and one or more processors coupled to the memory. The one or more processors may be configured to communicate with a UE to signal information related to an estimated ABR for each of one or more logical channels on at least one of an uplink or a downlink. The one or more processors may be configured to communicate traffic associated with the one or more logical channels according to a frame rate or a bit rate that is based at least in part on the information related to the estimated ABR for the one or more logical channels.

Some aspects described herein relate to a method of wireless communication performed by a UE. The method may include communicating with a network entity to signal information related to an estimated ABR for each of one or more logical channels on at least one of an uplink or a downlink. The method may include communicating traffic associated with the one or more logical channels according to a frame rate or a bit rate that is based at least in part on the information related to the estimated ABR for the one or more logical channels.

Some aspects described herein relate to a method of wireless communication performed by a network entity. The method may include communicating with a UE to signal information related to an estimated ABR for each of one or more logical channels on at least one of an uplink or a downlink. The method may include communicating traffic associated with the one or more logical channels according to a frame rate or a bit rate that is based at least in part on the information related to the estimated ABR for the one or more logical channels.

Some aspects described herein relate to a non-transitory computer-readable medium that stores a set of instructions for wireless communication by a UE. The set of instructions, when executed by one or more processors of the UE, may cause the UE to communicate with a network entity to signal information related to an estimated ABR for each of one or more logical channels on at least one of an uplink or a downlink. The set of instructions, when executed by one or more processors of the UE, may cause the UE to communicate traffic associated with the one or more logical channels according to a frame rate or a bit rate that is based at least in part on the information related to the estimated ABR for the one or more logical channels.

Some aspects described herein relate to a non-transitory computer-readable medium that stores a set of instructions for wireless communication by a network entity. The set of instructions, when executed by one or more processors of the network entity, may cause the network entity to communicate with a UE to signal information related to an estimated ABR for each of one or more logical channels on at least one of an uplink or a downlink. The set of instructions, when executed by one or more processors of the network entity, may cause the network entity to communicate traffic associated with the one or more logical channels according to a frame rate or a bit rate that is based at least in part on the information related to the estimated ABR for the one or more logical channels.

Some aspects described herein relate to an apparatus for wireless communication. The apparatus may include means for communicating with a network entity to signal information related to an estimated ABR for each of one or more logical channels on at least one of an uplink or a downlink. The apparatus may include means for communicating traffic associated with the one or more logical channels according to a frame rate or a bit rate that is based at least in part on the information related to the estimated ABR for the one or more logical channels.

Some aspects described herein relate to an apparatus for wireless communication. The apparatus may include means for communicating with a UE to signal information related to an estimated ABR for each of one or more logical channels on at least one of an uplink or a downlink. The apparatus may include means for communicating traffic associated with the one or more logical channels according to a frame rate or a bit rate that is based at least in part on the information related to the estimated ABR for the one or more logical channels.

Some aspects described herein relate to a UE for wireless communication. The UE may include a memory and one or more processors coupled to the memory. The one or more processors may be configured to receive, from a network entity, a configuration for wireless communication at the UE. The one or more processors may be configured to receive, from the network entity, multiple sets of parameters for the configuration. The one or more processors may be configured to transmit L1 or L2 signaling indicating, in response to a change in a traffic pattern at the UE, an updated traffic parameter or a set of parameters from the multiple sets of parameters. The one or more processors may be configured to receive, from the network entity, an indication to use one of the multiple sets of parameters. The one or more processors may be configured to communicate with the network entity based on the configuration and the one of the multiple sets of parameters.

Some aspects described herein relate to a network entity for wireless communication. The network entity may include a memory and one or more processors coupled to the memory. The one or more processors may be configured to configure a UE with a configuration for wireless communication at the UE. The one or more processors may be configured to configure the UE with multiple sets of parameters for the configuration. The one or more processors may be configured to receive L1 or L2 signaling indicating, in response to a change in a traffic pattern at the UE, an updated traffic parameter or a set of parameters from the multiple sets of parameters. The one or more processors may be configured to provide the UE with an indication to use one of the multiple sets of parameters. The one or more processors may be configured to communicate with the UE based on the configuration and the one of the multiple sets of parameters.

Some aspects described herein relate to a method of wireless communication performed by a UE. The method may include receiving, from a network entity, a configuration for wireless communication at the UE. The method may include receiving, from the network entity, multiple sets of parameters for the configuration. The method may include transmitting L1 or L2 signaling indicating, in response to a change in a traffic pattern at the UE, an updated traffic parameter or a set of parameters from the multiple sets of parameters. The method may include receiving, from the network entity, an indication to use one of the multiple sets of parameters. The method may include communicating with the network entity based on the configuration and the one of the multiple sets of parameters.

Some aspects described herein relate to a method of wireless communication performed by a network entity. The method may include configuring a UE with a configuration for wireless communication at the UE. The method may include configuring the UE with multiple sets of parameters for the configuration. The method may include receiving L1 or L2 signaling indicating, in response to a change in a traffic pattern at the UE, an updated traffic parameter or a set of parameters from the multiple sets of parameters. The method may include providing the UE with an indication to use one of the multiple sets of parameters. The method may include communicating with the UE based on the configuration and the one of the multiple sets of parameters.

Some aspects described herein relate to a non-transitory computer-readable medium that stores a set of instructions for wireless communication by a UE. The set of instructions, when executed by one or more processors of the UE, may cause the UE to receive, from a network entity, a configuration for wireless communication at the UE. The set of instructions, when executed by one or more processors of the UE, may cause the UE to receive, from the network entity, multiple sets of parameters for the configuration. The set of instructions, when executed by one or more processors of the UE, may cause the UE to transmit L1 or L2 signaling indicating, in response to a change in a traffic pattern at the UE, an updated traffic parameter or a set of parameters from the multiple sets of parameters. The set of instructions, when executed by one or more processors of the UE, may cause the UE to receive, from the network entity, an indication to use one of the multiple sets of parameters. The set of instructions, when executed by one or more processors of the UE, may cause the UE to communicate with the network entity based on the configuration and the one of the multiple sets of parameters.

Some aspects described herein relate to a non-transitory computer-readable medium that stores a set of instructions for wireless communication by a network entity. The set of instructions, when executed by one or more processors of the network entity, may cause the network entity to configure a UE with a configuration for wireless communication at the UE. The set of instructions, when executed by one or more processors of the network entity, may cause the network entity to configure the UE with multiple sets of parameters for the configuration. The set of instructions, when executed by one or more processors of the network entity, may cause the network entity to receive L1 or L2 signaling indicating, in response to a change in a traffic pattern at the UE, an updated traffic parameter or a set of parameters from the multiple sets of parameters. The set of instructions, when executed by one or more processors of the network entity, may cause the network entity to provide the UE with an indication to use one of the multiple sets of parameters. The set of instructions, when executed by one or more processors of the network entity, may cause the network entity to communicate with the UE based on the configuration and the one of the multiple sets of parameters.

Some aspects described herein relate to an apparatus for wireless communication. The apparatus may include means for receiving, from a network entity, a configuration for wireless communication at the apparatus. The apparatus may include means for receiving, from the network entity, multiple sets of parameters for the configuration. The apparatus may include means for transmitting L1 or L2 signaling indicating, in response to a change in a traffic pattern at the apparatus, an updated traffic parameter or a set of parameters from the multiple sets of parameters. The apparatus may include means for receiving, from the network entity, an indication to use one of the multiple sets of parameters. The apparatus may include means for communicating with the network entity based on the configuration and the one of the multiple sets of parameters.

Some aspects described herein relate to an apparatus for wireless communication. The apparatus may include means for configuring a UE with a configuration for wireless communication at the UE. The apparatus may include means for configuring the UE with multiple sets of parameters for the configuration. The apparatus may include means for receiving L1 or L2 signaling indicating, in response to a change in a traffic pattern at the UE, an updated traffic parameter or a set of parameters from the multiple sets of parameters. The apparatus may include means for providing the UE with an indication to use one of the multiple sets of parameters. The apparatus may include means for communicating with the UE based on the configuration and the one of the multiple sets of parameters.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a disaggregated base station, in accordance with the present disclosure.

FIGS. 4-5 are diagrams illustrating examples associated with signaling for frame rate and/or bit rate indication and inquiry related to traffic with a high data rate, in accordance with the present disclosure.

FIGS. 6-7 are diagrams illustrating example processes associated with signaling for frame rate and/or bit rate indication and inquiry related to traffic with a high data rate, in accordance with the present disclosure.

FIG. 8 is a diagram illustrating examples of extended reality (XR) traffic, in accordance with the present disclosure.

FIG. 9 is a diagram illustrating examples of discontinuous reception (DRX) configurations, in accordance with the present disclosure.

FIG. 10 is a diagram illustrating an example communication flow for UE assistance information that a UE may provide to a network to trigger a reconfiguration based on a change in traffic parameters, in accordance with the present disclosure.

FIG. 11 is a diagram illustrating an example communication flow using Layer 1 (L1) or Layer 2 (L2) signaling to enable faster reconfiguration of a UE in response to changes in traffic at the UE, in accordance with the present disclosure.

FIG. 12 is a diagram illustrating examples of L2 signaling to enable faster reconfiguration of a UE in response to changes in traffic at the UE, in accordance with the present disclosure.

FIGS. 13-14 are diagrams illustrating example processes associated with using L1/L2 signaling to enable faster reconfiguration of a UE in response to changes in traffic at the UE, in accordance with the present disclosure.

FIGS. 15-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

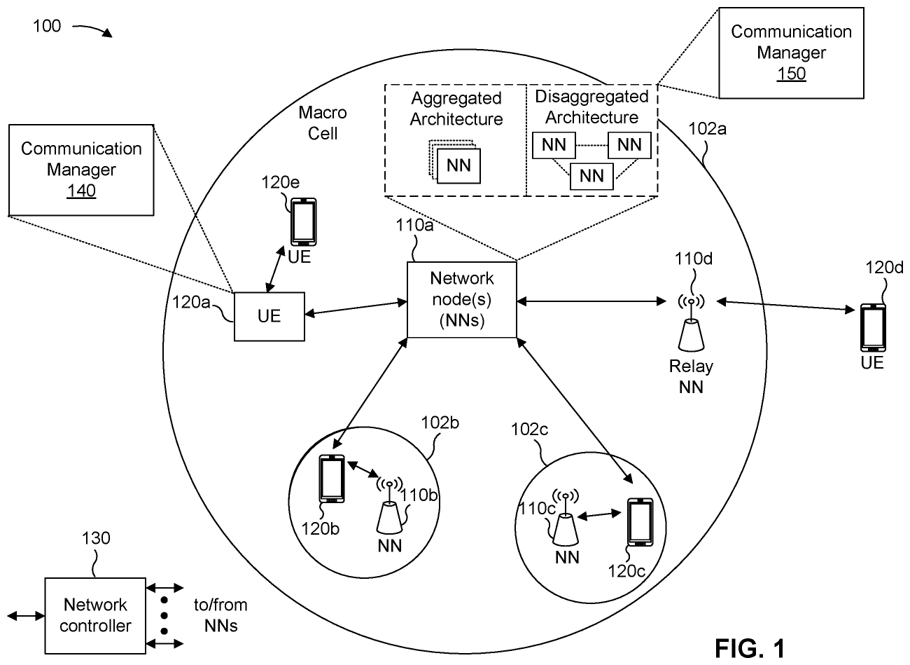

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a radio protocol stack that is physically or logically distributed among two or more nodes (such as one or more central units (CUs), one or more distributed units (DUs), or one or more radio units (RUs)).

In some examples, a network node 110 is or includes a network entity that communicates with UEs 120 via a radio access link, such as an RU. In some examples, a network node 110 is or includes a network entity that communicates with other network nodes 110 via a fronthaul link or a midhaul link, such as a DU. In some examples, a network node 110 is or includes a network entity that communicates with other network nodes 110 via a midhaul link or a core network via a backhaul link, such as a CU. In some aspects, a network node 110 (such as an aggregated network node 110 or a disaggregated network node 110) may include multiple network nodes, such as one or more RUs, one or more DUs, and/or one or more CUs. A network node 110 may include, for example, an NR base station, an LTE base station, a Node B, an eNB (e.g., in 4G), a gNB (e.g., in 5G), an access point, a transmission reception point (TRP), an RU, a DU, a CU, a mobility element of a network, a core network node, a network element, a network equipment, a RAN node, or a combination thereof. In some examples, the network nodes 110 may be interconnected to one another and/or to one or more other network nodes 110 in the wireless network 100 through various types of fronthaul, midhaul, and/or backhaul interfaces, such as a direct physical connection, an air interface, or a virtual network, using any suitable transport network.

In some aspects, a network node 110 may provide communication coverage for a particular geographic area. In the Third Generation Partnership Project (3GPP), the term “cell” can refer to a coverage area of a base station and/or a base station subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station for a macro cell may be referred to as a macro base station. A base station for a pico cell may be referred to as a pico base station. A base station for a femto cell may be referred to as a femto base station or an in-home base station. In the example shown in FIG. 1, the network node 110a may be a macro base station for a macro cell 102a, the network node 110b may be a pico base station for a pico cell 102b, and the network node 110c may be a femto base station for a femto cell 102c. A base station may support one or multiple (e.g., three) cells.

In some examples, a cell may not necessarily be stationary, and the geographic area of the cell may move according to the location of a network node 110 that is mobile (e.g., a mobile base station).

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120 or network nodes 110. In the example shown in FIG. 1, the network node 110d (e.g., a relay base station) may communicate with the network node 110a (e.g., a macro base station) and the UE 120d in order to facilitate communication between the network node 110a and the UE 120d. A network node 110 that relays communications may be referred to as a relay station, a relay base station, a relay node, a relay, or the like.

The wireless network 100 may be a heterogeneous network that includes network nodes 110 of different types, such as macro base stations, pico base stations, femto base stations, relay base stations, TRPs, RUs, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul or midhaul communication link. The network nodes 110 may communicate with one another directly or indirectly via a wireless or wireline backhaul communication link. In some aspects, the network controller 130 may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may communicate with a network entity (e.g., a network node 110) to signal information related to an estimated available bit rate (ABR) for each of one or more logical channels on at least one of an uplink or a downlink; and communicate traffic associated with the one or more logical channels according to a frame rate or a bit rate that is based at least in part on the information related to the estimated ABR for the one or more logical channels. Additionally, or alternatively, the communication manager 140 may receive, from a network entity (e.g., a network node 110), a configuration for wireless communication at the UE 120; receive, from the network entity, multiple sets of parameters for the configuration; transmit Layer 1 (L1) or Layer 2 (L2) signaling indicating, in response to a change in a traffic pattern at the UE 120, an updated traffic parameter or a set of parameters from the multiple sets of parameters; receive, from the network entity, an indication to use one of the multiple sets of parameters; and communicate with the network entity based on the configuration and the one of the multiple sets of parameters. Additionally, or alternatively, the communication manager 140 may perform one or more other operations described herein.

In some aspects, a network entity (e.g., a network node 110) may include a communication manager 150. As described in more detail elsewhere herein, the communication manager 150 may communicate with a UE 120 to signal information related to an estimated ABR for each of one or more logical channels on at least one of an uplink or a downlink; and communicate traffic associated with the one or more logical channels according to a frame rate or a bit rate that is based at least in part on the information related to the estimated ABR for the one or more logical channels. Additionally, or alternatively, the communication manager 150 may configure a UE 120 with a configuration for wireless communication at the UE 120; configure the UE 120 with multiple sets of parameters for the configuration; receive L1 or L2 signaling indicating, in response to a change in a traffic pattern at the UE 120, an updated traffic parameter or a set of parameters from the multiple sets of parameters; provide the UE 120 with an indication to use one of the multiple sets of parameters; and communicate with the UE 120 based on the configuration and the one of the multiple sets of parameters. Additionally, or alternatively, the communication manager 150 may perform one or more other operations described herein.

As indicated above, FIG. 1 is provided as an example. Other examples may differ from what is described with regard to FIG. 1.

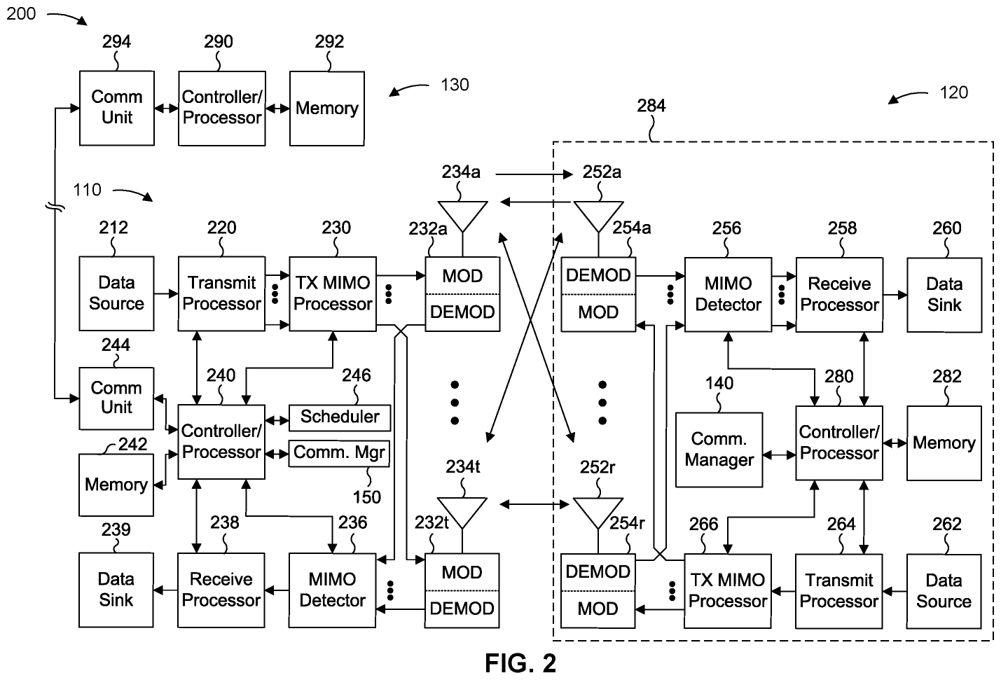

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. For example, some network nodes 110 may not include radio frequency components.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

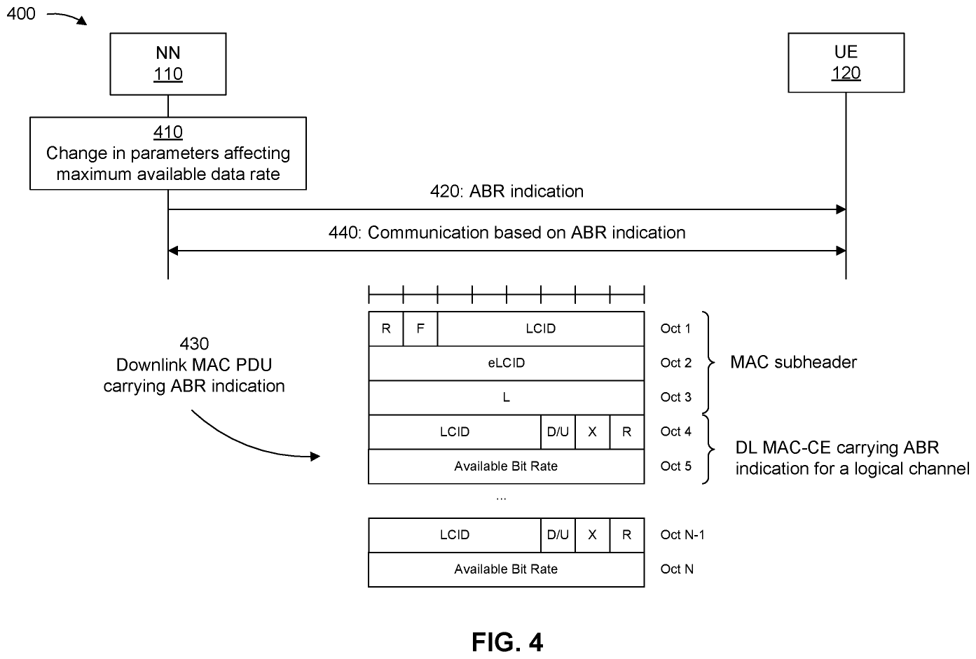

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

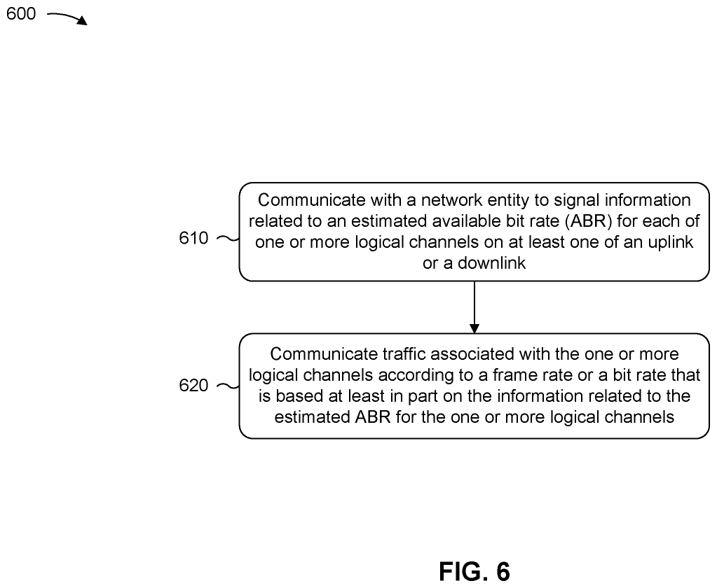

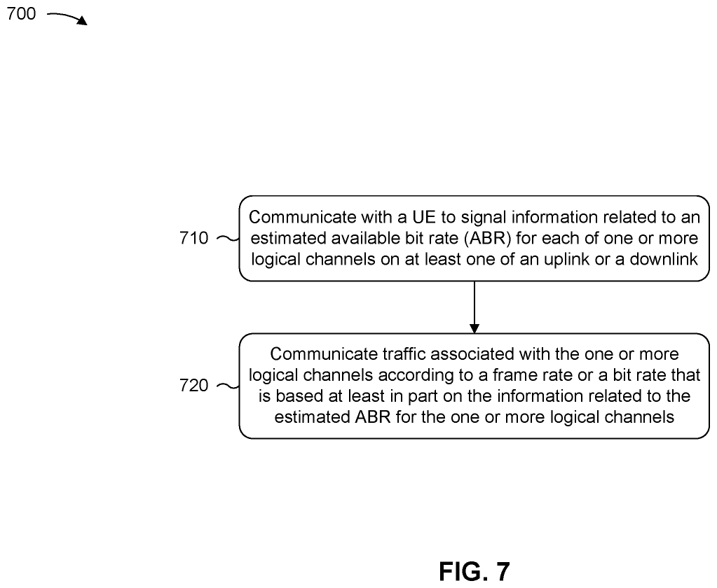

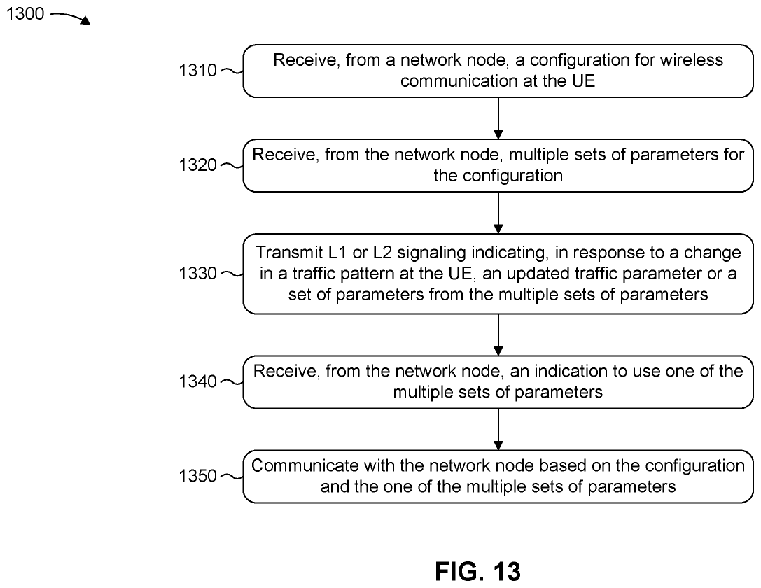

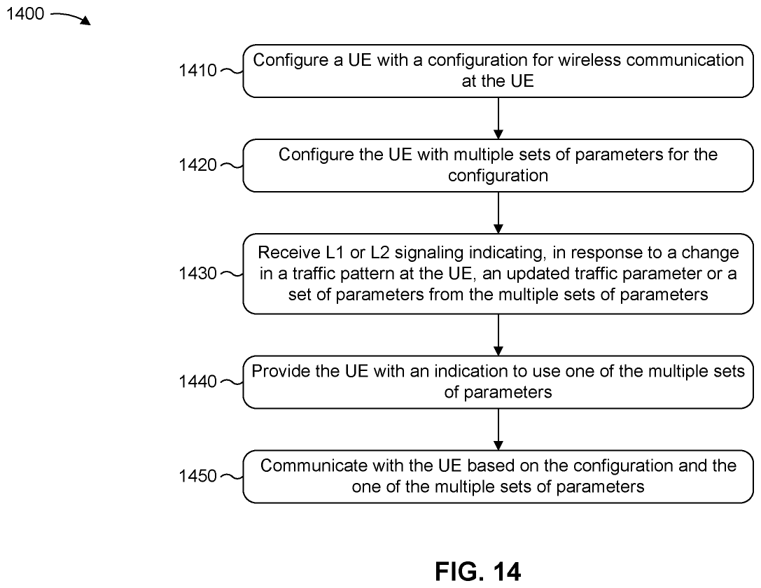

The controller/processor 240 of the network node 110, the controller/processor 280 of the UE 120, and/or any other component(s) of FIG. 2 may perform one or more techniques associated with signaling for frame rate and/or bit rate indication and inquiry related to traffic with a high data rate, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for communicating with a network entity (e.g., the network node 110) to signal information related to an estimated ABR for each of one or more logical channels on at least one of an uplink or a downlink; and/or means for communicating traffic associated with the one or more logical channels according to a frame rate or a bit rate that is based at least in part on the information related to the estimated ABR for the one or more logical channels. Additionally, or alternatively, the UE 120 includes means for receiving, from a network entity (e.g., the network node 110), a configuration for wireless communication at the UE 120; means for receiving, from the network entity, multiple sets of parameters for the configuration; means for transmitting L1 or L2 signaling indicating, in response to a change in a traffic pattern at the UE 120, an updated traffic parameter or a set of parameters from the multiple sets of parameters; means for receiving, from the network entity, an indication to use one of the multiple sets of parameters; and/or means for communicating with the network entity based on the configuration and the one of the multiple sets of parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the network node 110) includes means for communicating with a UE 120 to signal information related to an estimated ABR for each of one or more logical channels on at least one of an uplink or a downlink; and/or means for communicating traffic associated with the one or more logical channels according to a frame rate or a bit rate that is based at least in part on the information related to the estimated ABR for the one or more logical channels. Additionally, or alternatively, the network entity includes means for configuring a UE 120 with a configuration for wireless communication at the UE 120; means for configuring the UE 120 with multiple sets of parameters for the configuration; means for receiving L1 or L2 signaling indicating, in response to a change in a traffic pattern at the UE 120, an updated traffic parameter or a set of parameters from the multiple sets of parameters; means for providing the UE 120 with an indication to use one of the multiple sets of parameters; and/or means for communicating with the UE 120 based on the configuration and the one of the multiple sets of parameters. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

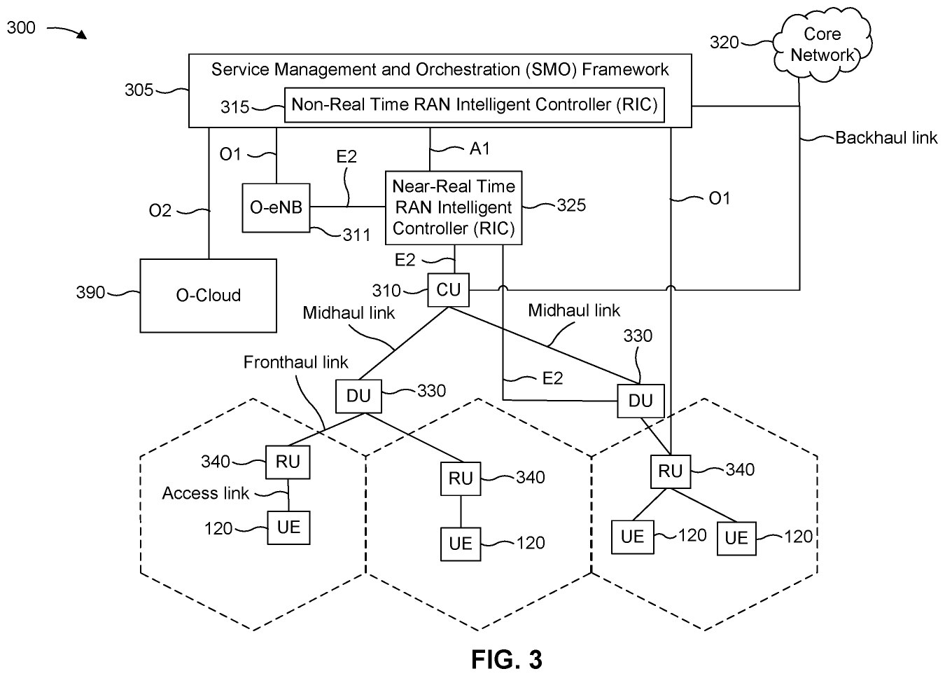

FIG. 3 is a diagram illustrating an example of a disaggregated base station, in accordance with the present disclosure.

Deployment of communication systems, such as 5G NR systems, may be arranged in multiple manners with various components or constituent parts. In a 5G NR system, or network, a network node may be implemented in an aggregated architecture or a disaggregated architecture. For example, a network node, or one or more units (or one or more components) performing network node functionality, may be implemented as an aggregated network node (sometimes referred to as a standalone base station or a monolithic base station) or a disaggregated network node. “Network entity” or “network node” may refer to a disaggregated network node, an aggregated network node, or one or more entities of a disaggregated network node (such as one or more CUs, one or more DUs, one or more RUs, or a combination thereof).

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (MC) 325 via an E2 link, a Non-Real Time (Non-RT) MC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

There are existing and ongoing efforts to configure cellular networks to support extended reality (XR) traffic, which is an umbrella term that covers immersive technologies such as virtual reality (VR), augmented reality (AR), mixed reality (MR), and levels of virtuality interpolated among VR, AR, and MR. For example, VR is a rendered version of an audiovisual scene, where the rendering is designed to mimic the visual and audio sensory stimuli of the real world as naturally as possible to an observer or a user as they move within the limits defined by the VR application. VR typically requires a user to wear a head mounted display (HMD) to completely replace a field of view with a simulated visual component, and to use headphones, a speaker, and/or another suitable audio device to hear the accompanying audio. Head and motion tracking of the user is usually also needed in VR applications to allow the simulated visual and audio components to be updated in order to ensure that, from the perspective of the user, items and sound sources remain consistent with movements of the user. In AR applications, a user is generally provided with additional information or artificially generated items or content that are overlaid upon a current environment. The additional information or content is usually visual and/or audible and observation of the current environment may be direct, with no intermediate sensing, processing and rendering, or indirect, where perception of the environment may be relayed via sensors and enhanced or processed. MR is an advanced form of AR where some virtual elements are inserted into a physical scene to provide an illusion that the elements are part of the real scene.

XR is expected to improve productivity and convenience for consumers, enterprises, and public institutions in various application areas such as entertainment, training, education, remote support, remote control, communications, and/or virtual meetings, among other examples. XR can be used in many industry segments, including health care, real estate, shopping, transportation, manufacturing, and/or other industry segments. VR is already used for gaming both at home and at dedicated venues, for virtual tours in the context of real estate, for education and training purposes, and for remote participation at live events such as concerts and sports. Furthermore, AR and MR use cases have significant potential. For example, whereas VR applications rely on HMDs that separate users from physical surroundings and restrict mobility, AR and MR applications allow users to be present in reality and move freely even when using HMDs. Many smartphone users have already experienced basic forms of AR, through games that involve searching for virtual objects in real-world environments and apps that enable shoppers to visualize new furniture in their homes before making a purchase. Furthermore, AR technology may be used with an HMD to free a user's hands, and thereby increase worker efficiency by providing an ability to overlay information on the real world while simultaneously having hands available.

However, configuring a wireless network to support the latency requirements, quality of experience (QoE) requirements, high data rates, and/or other characteristics associated with XR traffic presents various challenges. For example, at an XR-enabled UE, XR traffic may include pose, video, and/or other data transmitted by and/or to the XR-enabled UE, may have a varying video frame size over time, and/or may have quasi-periodic packet arrival times with application jitter (e.g., variations in delays and/or arrival times for XR traffic). Furthermore, traffic arrival time at a network node (e.g., a RAN node) is periodic with non-negligible jitter due to uncertain application processing times. Video frame sizes are an order of magnitude larger than packets in voice or industrial control communications, in addition to not being fixed over time. Rather, segmentation of each frame is expected, which implies that packets arrive in bursts that must be handled together to meet stringent bounded latency requirements. Accordingly, because XR applications have very high data rates that may approach a maximum bandwidth available on an air interface, XR applications often need to adapt traffic patterns to match the ABR over the air interface, where the ABR may refer to the number of bits that are conveyed per unit of time. For example, when channel conditions degrade and the ABR is reduced, an XR application may need to reduce a frame rate defining a frequency at which consecutive images are displayed (e.g., from frames per second (FPS) down to 30 FPS) and/or reduce an encoding (e.g., from 4K down to High-Definition (HD)) to match the ABR over the interface. Similarly, when channel conditions improve and the ABR increases, an XR application may increase the frame rate and/or the encoding to take advantage of the higher ABR. Accordingly, an XR application may need to know what data rate is available or supportable over an air interface in order to maintain suitable performance and QoE.

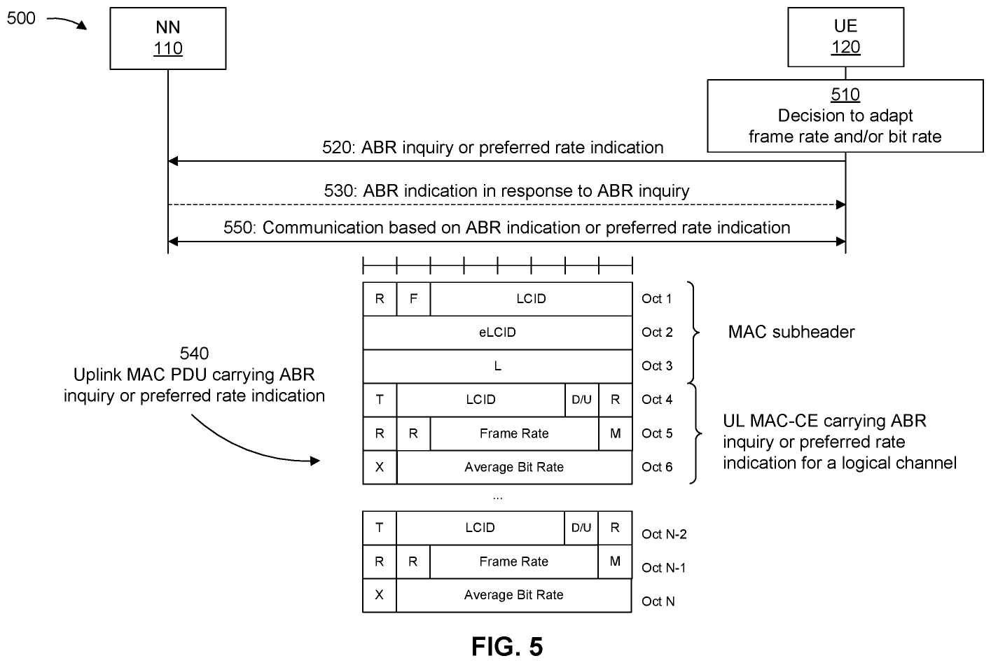

Some aspects described herein relate to techniques to signal information related to a frame rate and/or a bit rate for applications associated with a high data rate, such as XR applications, to enable or support traffic adaptation by the applications associated with the high data rate. For example, some aspects described herein relate to a network-driven or network-initiated signaling technique, where a network node may transmit an ABR indication to a UE running an application associated with a high data rate based on one or more triggering events that may affect a maximum data rate available on an air interface (e.g., link quality over the air interface may fluctuate due to events such as mobility, interference, loading, enabling or deactivating a secondary carrier, an impending handover, and/or other suitable events that may cause a change in the maximum data rate available on the air interface). In such cases, as described in further detail below with reference to FIG. 4, the network node may provide the ABR indication to the UE to indicate the ABR over the air interface, which may enable the UE to dynamically adapt a frame rate or encoding to match the ABR over the air interface. Additionally, or alternatively, some aspects described herein relate to a UE-driven or UE-initiated signaling technique, where a UE may transmit an ABR inquiry to a network node based on one or more triggering events, such as user movement or a change in battery status (e.g., the UE may inquire about the ABR over the air interface when the battery of the UE is running low in order to reduce a frame rate to save power). In such cases, as described in further detail below with reference to FIG. 5, the network node may provide the ABR indication to the UE to indicate the ABR over the air interface, which may enable the UE to dynamically adapt a frame rate or encoding to match the ABR over the air interface. Additionally, or alternatively, in a UE-driven or UE-initiated signaling technique, the UE may transmit a preferred rate indication to indicate a new frame rate and/or bit rate to be used by the UE based on the one or more triggering events, which may enable the network node to dynamically adapt one or more control configurations based on an updated traffic pattern that may depend on factors such as a frame rate or an encoding rate (e.g., aligning a downlink semi-persistent scheduling (SPS) or uplink configured grant configuration with a discontinuous reception (DRX) configuration to match the periodicity of the traffic so that the UE can sleep more efficiently between traffic bursts).

FIG. 4 is a diagram illustrating an example 400 associated with signaling for frame rate and/or bit rate indication and inquiry related to traffic with a high data rate, in accordance with the present disclosure. As shown in FIG. 4, example 400 includes communication between a UE 120 and a network node 110 (e.g., a base station or a component of a base station, such as an RU, a DU, and/or a CU). In some aspects, the network node 110 and the UE 120 may be included in a wireless network, such as wireless network 100. The network node 110 and the UE 120 may communicate via a wireless access link, which may include an uplink and a downlink.

As shown in FIG. 4, and by reference number 410, the network node 110 may detect a change in one or more parameters that affect a maximum available data rate associated with one or more logical channels that are used to carry traffic for one or more applications running on the UE 120 (e.g., one or more XR applications and/or other applications that have a high data rate). For example, in some aspects, the change in the one or more parameters may generally impact link quality over an air interface, which may result in an increase or a decrease to the maximum available data rate for the one or more logical channels that are used to carry uplink and/or downlink traffic over the air interface. For example, the maximum available data rate associated with the one or more logical channels may increase or decrease due to UE mobility (e.g., one or more impending handovers), a change in interference conditions, a change in loading, activation or deactivation of communication resources (e.g., a bandwidth part, a carrier, and/or a cell group), and/or a change in a configuration of the network node 110, among other examples. Accordingly, as shown by reference number 420, the network node 110 may transmit an ABR indication to the UE 120 to indicate the ABR (e.g., the maximum available data rate) in an uplink direction and/or a downlink direction per logical channel. In this way, the network node 110 and the UE 120 may process uplink and/or downlink traffic carried over the one or more logical channels according to a frame rate and/or a bit rate that is based on the ABR indication. For example, in some aspects, the UE 120 may dynamically adapt a frame rate and/or an encoding rate for uplink and/or downlink traffic carried on a logical channel based on the ABR indication for the logical channel. Additionally, or alternatively, the network node 110 may adapt one or more control configurations (e.g., a configuration related to downlink SPS, uplink configured grant, DRX, or the like) based on the ABR for the logical channel.

In some aspects, as shown in FIG. 4, and by reference number 430, the network node 110 may signal the ABR for one or more logical channels in a downlink MAC protocol data unit (PDU). For example, as shown in FIG. 4, the downlink MAC PDU may include a MAC subheader and one or more downlink MAC control elements (MAC-CEs) that each carry an ABR indication for an associated logical channel, where the downlink MAC-CE may have a similar format as a Recommended Bit Rate MAC-CE (e.g., as defined in TS 38.321, version 17.0.0, Section 6.1.3.20). For example, as shown in FIG. 4, the downlink MAC-CE that carries the ABR indication for a logical channel may include two octets, which may include a first octet having a logical channel identifier (LCD) field to indicate an identifier of the logical channel for which the ABR indication is applicable, a downlink/uplink (DL/UL or D/U) field or an uplink/downlink (U/D or UL/DL) field to indicate whether the ABR indication applies to uplink or downlink traffic (e.g., set to 0 to indicate downlink or to 1 to indicate uplink, or vice versa), a bit rate multiplier (X) field (e.g., based on a bitRateMultiplier parameter configured for the associated logical channel via RRC signaling), and one or more reserved bits (R). Furthermore, as shown in FIG. 4, the downlink MAC-CE may include a second octet, which may include an available bit rate (or ABR) field to indicate the maximum bit rate that is available for downlink or uplink traffic carried over the logical channel indicated by the LCID field.

In this way, the ABR indication provided from the network node 110 to the UE 120 may indicate the maximum ABR (e.g., a physical layer ABR) that is available for a logical channel in an uplink and/or downlink direction (e.g., the network node 110 may configure the MAC PDU to include a first MAC-CE for an uplink ABR indication and a second MAC-CE for an uplink ABR indication to indicate the maximum ABR in uplink and downlink directions for a particular logical channel). Accordingly, as shown by reference number 440, the UE 120 and the network node 110 may communicate based on the ABR indication. For example, the network node 110 may transmit downlink traffic to the UE 120 and/or receive uplink traffic from the UE 120 based on the ABR indication. The UE 120 may process and/or communicate (e.g., transmit and/or receive) traffic carried over each logical channel associated with an ABR indication according to a frame rate or a bit rate that is based on the corresponding ABR indication. Furthermore, the network node 110 may adapt one or more control configurations or otherwise process and/or communicate (e.g., transmit and/or receive) traffic carried over each logical channel associated with an ABR indication according to the corresponding ABR indication (e.g., configuring SPS occasions in which downlink traffic is sent to the UE 120 or configured grant occasions in which uplink traffic is received from the UE 120 to be aligned with a DRX active time).

As indicated above, FIG. 4 is provided as an example. Other examples may differ from what is described with regard to FIG. 4.

FIG. 5 is a diagram illustrating an example 500 associated with signaling for frame rate and/or bit rate indication and inquiry related to traffic with a high data rate, in accordance with the present disclosure. As shown in FIG. 5, example 500 includes communication between a UE 120 and a network node 110 (e.g., a base station or a component of a base station, such as an RU, a DU, and/or a CU). In some aspects, the network node 110 and the UE 120 may be included in a wireless network, such as wireless network 100. The network node 110 and the UE 120 may communicate via a wireless access link, which may include an uplink and a downlink.

As shown in FIG. 5, and by reference number 510, the UE 120 may decide to adapt a frame rate and/or a bit rate associated with one or more logical channels that are used to carry traffic for one or more applications running on the UE 120 (e.g., one or more XR applications and/or other applications that have a high data rate). For example, in some aspects, the decision to adapt the frame rate and/or the bit rate may be based on a change one or more parameters that relate to a status of the UE 120, such as movement of the UE 120, a change in power status of the UE 120 (e.g., available battery life falling below a threshold), and/or a change in behavior by a user of the UE 120. Accordingly, as shown by reference number 520, the UE 120 may transmit one or more messages to the network node 110 to enable the UE 120 to dynamically adapt the frame rate and/or the bit rate for the one or more logical channels. For example, in some aspects, the UE 120 may determine a new frame rate and/or a new bit rate to be applied to traffic carried over one or more logical channels, and the one or more messages transmitted to the network node 110 may include a preferred rate indication to indicate the new frame rate and/or the new bit rate that the UE 120 will apply to the traffic carried over one or more logical channels. Additionally, or alternatively, the UE 120 may transmit an ABR inquiry to the network node 110 to request that the network node 110 provide an ABR indication for the one or more logical channels (e.g., in an uplink and/or downlink direction based on an ABR estimated by the network node 110). In such cases, as shown by reference number 530, the network node 110 may estimate the ABR for one or more logical channels that the UE 120 inquired about and transmit an ABR indication to the UE 120 (e.g., using the downlink MAC-CE described above with reference to FIG. 4), and the UE 120 may then determine an appropriate frame rate and/or bit rate based on the ABR indication provided by the network node 110.

In some aspects, as shown in FIG. 5, and by reference number 540, the UE 120 may provide the ABR inquiry and/or the preferred rate indication for one or more logical channels in an uplink MAC PDU. For example, as shown in FIG. 5, the uplink MAC PDU may include a MAC subheader and one or more uplink MAC-CEs that each carry either an ABR inquiry or a preferred rate indication for an associated logical channel, where the uplink MAC-CE may have a similar format as a Recommended Bit Rate MAC-CE (e.g., as defined in TS 38.321, version 17.0.0, Section 6.1.3.20). For example, as shown in FIG. 5, the uplink MAC-CE that carries the ABR inquiry or preferred rate indication for a logical channel may include an LCID field to indicate an identifier of the logical channel to which the ABR inquiry or preferred rate indication is applicable, a field to indicate whether the ABR inquiry or preferred rate indication applies to uplink or downlink traffic (e.g., set to 0 to indicate downlink or to 1 to indicate uplink, or vice versa), a bit rate multiplier (X) field (e.g., based on a bitRateMultiplier parameter configured for the associated logical channel via RRC signaling), and one or more reserved bits (R). Furthermore, as shown in FIG. 5, the uplink MAC-CE may include a type field (T) to indicate whether the MAC-CE is an ABR inquiry or a preferred rate indication and a more field (M) to indicate whether the MAC-CE includes an additional (e.g., third) octet. In some aspects, in cases where the type field indicates that the MAC-CE includes an ABR inquiry, a frame rate field may optionally indicate a frame rate to inquire about the ABR at the frame rate indicated in the frame rate field. Furthermore, in cases where the type field indicates that the MAC-CE includes an ABR inquiry, the more field may indicate that no additional octet is included in the MAC-CE. Alternatively, in cases where the type field indicates that the MAC-CE includes a preferred rate indication, the frame rate field may indicate the frame rate that the UE 120 will use to process downlink or uplink traffic carried over the associated logical channel, and an average bit rate field may indicate the average bit rate that the UE 120 will use to process downlink or uplink traffic carried over the associated logical channel. In cases where the average bit rate field is included, the more field may indicate that an additional octet is included in the MAC-CE, or the more field may indicate that the MAC-CE does not include an additional octet in cases where the average bit rate field is not included.

Alternatively, rather than providing the ABR inquiry or preferred rate indication in an uplink MAC-CE, the UE 120 may provide the ABR inquiry or preferred rate indication in UE assistance information (UAI) carried in one or more RRC messages. For example, in order to inquire about the ABR for one or more logical channels, the UAI may include one or more parameters to indicate a message type (e.g., that the message is an inquiry for an available bit rate), a set of one or more logical channels associated with the inquiry, and/or a target frame rate for the one or more logical channels associated with the inquiry. Additionally, or alternatively, in order to indicate a preferred new rate for one or more logical channels, the UAI may include one or more parameters to indicate a message type (e.g., that the message is a preferred rate indication), one or more new rates that the UE 120 will use to generate traffic for a logical channel, and/or information related to when the new rate(s) will become effective (e.g., specified in terms of a system frame number (SFN) and a starting offset indicating a number of slots from the start of the specified SFN). For example, in some aspects, the one or more new rates indicated in the UAI may include only a new bit rate, only a new frame rate, or both a new bit rate and a new frame rate.

As described herein, among the available signaling techniques for the ABR inquiry and/or preferred rate indication (e.g., uplink MAC-CE or UAI), the uplink MAC-CE is a Layer 2 (L2) signaling that may offer a lower latency or a shorter delay than UAI, which is RRC (Layer 3 (L3)) signaling. Furthermore, the uplink MAC-CE would be processed at a DU of the network node 110 (or the network node 110 may be a DU), which is the same node that estimates or generates the ABR information. In contrast, because UAI is an RRC message, the UAI would need to be processed in a core network, which may result in a much longer delay. Accordingly, the uplink MAC-CE may be well-suited to XR applications or other applications that require a shorter latency or delay. However, the UAI may offer more flexibility than the uplink MAC-CE, and therefore may be well-suited to use cases where the UE 120 needs to indicate more detailed parameters (e.g., a target frame rate for an ABR inquiry and/or a time when a new bit rate and/or frame rate will become effective).

In this way, when the UE 120 provides an ABR inquiry for one or more logical channels, the subsequent ABR indication provided from the network node 110 to the UE 120 may indicate the maximum ABR (e.g., a physical layer ABR) that is available for a logical channel in an uplink and/or downlink direction. Accordingly, as shown by reference number 550, the UE 120 and the network node 110 may communicate based on the ABR indication or preferred rate indication. For example, the UE 120 may process and/or communicate (e.g., transmit and/or receive) traffic carried over each logical channel associated with an ABR indication according to a frame rate or a bit rate that is based on the corresponding ABR indication. Furthermore, the network node 110 may adapt one or more control configurations or otherwise process and/or communicate (e.g., transmit and/or receive) traffic carried over each logical channel associated with an ABR indication according to the corresponding ABR indication (e.g., configuring SPS or configured grant occasions to be aligned with a DRX active time). Additionally, or alternatively, when the UE 120 provides a preferred rate indication for one or more logical channels, the network node 110 may appropriately adapt one or more control configurations or otherwise process traffic based on the new frame rate and/or the new bit rate that the UE 120 will use to generate traffic over each logical channel associated with a preferred rate indication.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with signaling for frame rate and/or bit rate indication and inquiry related to traffic with a high data rate.

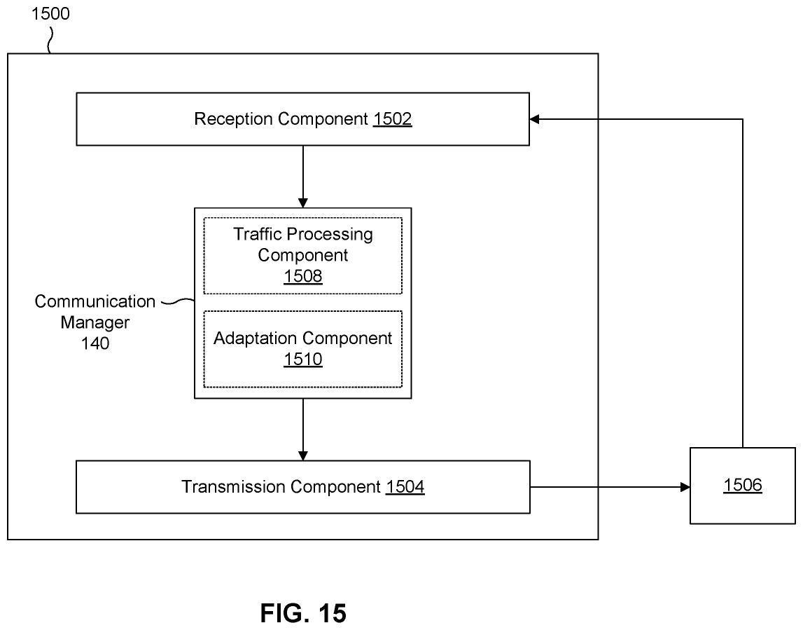

As shown in FIG. 6, in some aspects, process 600 may include communicating with a network entity to signal information related to an estimated ABR for each of one or more logical channels on at least one of an uplink or a downlink (block 610). For example, the UE (e.g., using communication manager 140, reception component 1502, and/or transmission component 1504, depicted in FIG. 15) may communicate with a network entity to signal information related to an estimated ABR for each of one or more logical channels on at least one of an uplink or a downlink, as described above.

As further shown in FIG. 6, in some aspects, process 600 may include communicating traffic associated with the one or more logical channels according to a frame rate or a bit rate that is based at least in part on the information related to the estimated ABR for the one or more logical channels (block 620). For example, the UE (e.g., using communication manager 140 and/or traffic processing component 1508, depicted in FIG. 15) may communicate traffic associated with the one or more logical channels according to a frame rate or a bit rate that is based at least in part on the information related to the estimated ABR for the one or more logical channels, as described above.

Process 600 may include additional aspects, such as any single aspect or any combination of aspects described below and/or in connection with one or more other processes described elsewhere herein.

In a first aspect, communicating with the network entity to signal the information related to the estimated ABR includes receiving, from the network entity, downlink signaling including an ABR indication for the one or more logical channels.

In a second aspect, alone or in combination with the first aspect, communicating with the network entity to signal the information related to the estimated ABR further includes transmitting, to the network entity, uplink signaling that includes an ABR inquiry for the one or more logical channels, wherein the ABR indication is based at least in part on the ABR inquiry.

In a third aspect, alone or in combination with one or more of the first and second aspects, communicating with the network entity to signal the information related to the estimated ABR includes transmitting, to the network entity, uplink signaling that includes a preferred rate indication for the one or more logical channels.

In a fourth aspect, alone or in combination with one or more of the first through third aspects, the information related to the estimated ABR is signaled in a MAC-CE.

In a fifth aspect, alone or in combination with one or more of the first through fourth aspects, the MAC-CE includes, for each of the one or more logical channels, an identifier of a respective logical channel and a field that indicates whether the MAC-CE is related to the estimated ABR for uplink traffic or downlink traffic associated with the respective logical channel.

In a sixth aspect, alone or in combination with one or more of the first through fifth aspects, the MAC-CE is a downlink MAC-CE received from the network entity that includes, for each of the one or more logical channels, an ABR indication that indicates the estimated ABR for a respective logical channel.

In a seventh aspect, alone or in combination with one or more of the first through sixth aspects, the MAC-CE is an uplink MAC-CE transmitted to the network entity that includes, for each of the one or more logical channels, a field to indicate whether the uplink MAC-CE carries an inquiry or an indication related to the estimated ABR for a respective logical channel.

In an eighth aspect, alone or in combination with one or more of the first through seventh aspects, the uplink MAC-CE includes, in a field carrying an inquiry related to the estimated ABR for a logical channel among the one or more logical channels, an indicated frame rate to inquire about the estimated ABR for the logical channel at the indicated frame rate.

In a ninth aspect, alone or in combination with one or more of the first through eighth aspects, the uplink MAC-CE indicates, in one or more fields carrying an indication related to the estimated ABR for a logical channel among the one or more logical channels, the frame rate and the bit rate to be used for the traffic associated with the logical channel.

In a tenth aspect, alone or in combination with one or more of the first through ninth aspects, the information related to the estimated ABR is signaled in UAI transmitted to the network entity.

In an eleventh aspect, alone or in combination with one or more of the first through tenth aspects, the UAI indicates that a message carrying the UAI is an inquiry about the estimated ABR for the one or more logical channels, indicates the one or more logical channels associated with the inquiry, and indicates a target frame rate for the one or more logical channels associated with the inquiry.

In a twelfth aspect, alone or in combination with one or more of the first through eleventh aspects, the UAI indicates that a message carrying the UAI is a rate indication for the one or more logical channels, indicates a new value for one or more of the frame rate or the bit rate to be used for the traffic associated with the one or more logical channels, and indicates when the new value will become effective.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network entity, in accordance with the present disclosure. Example process 700 is an example where the network entity (e.g., network node 110) performs operations associated with signaling for frame rate and/or bit rate indication and inquiry related to traffic with a high data rate.

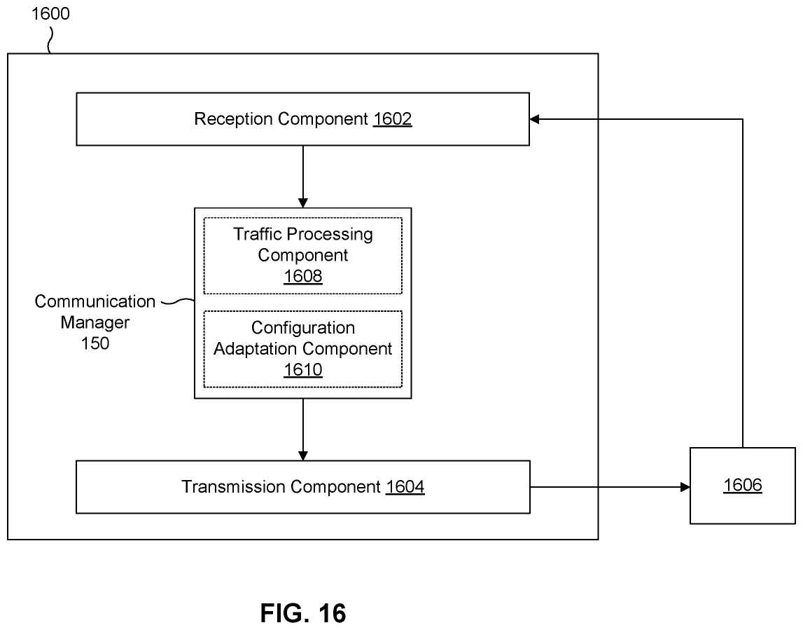

As shown in FIG. 7, in some aspects, process 700 may include communicating with a UE to signal information related to an estimated ABR for each of one or more logical channels on at least one of an uplink or a downlink (block 710). For example, the network entity (e.g., using communication manager 150, reception component 1602, and/or transmission component 1604, depicted in FIG. 16) may communicate with a UE to signal information related to an estimated ABR for each of one or more logical channels on at least one of an uplink or a downlink, as described above.

As further shown in FIG. 7, in some aspects, process 700 may include communicating traffic associated with the one or more logical channels according to a frame rate or a bit rate that is based at least in part on the information related to the estimated ABR for the one or more logical channels (block 720). For example, the network entity (e.g., using communication manager 150 and/or traffic processing component 1608, depicted in FIG. 16) may communicate traffic associated with the one or more logical channels according to a frame rate or a bit rate that is based at least in part on the information related to the estimated ABR for the one or more logical channels, as described above.

Process 700 may include additional aspects, such as any single aspect or any combination of aspects described below and/or in connection with one or more other processes described elsewhere herein.

In a first aspect, communicating with the UE to signal the information related to the estimated ABR includes transmitting, to the UE, downlink signaling including an ABR indication for the one or more logical channels.

In a second aspect, alone or in combination with the first aspect, communicating with the UE to signal the information related to the estimated ABR further includes receiving, from the UE, uplink signaling that includes an ABR inquiry for the one or more logical channels, wherein the ABR indication is based at least in part on the ABR inquiry.

In a third aspect, alone or in combination with one or more of the first and second aspects, communicating with the UE to signal the information related to the estimated ABR includes receiving, from the UE, uplink signaling that includes a preferred rate indication for the one or more logical channels.

In a fourth aspect, alone or in combination with one or more of the first through third aspects, the information related to the estimated ABR is signaled in a MAC-CE.

In a fifth aspect, alone or in combination with one or more of the first through fourth aspects, the MAC-CE includes, for each of the one or more logical channels, an identifier of a respective logical channel and a field that indicates whether the MAC-CE is related to the estimated ABR for uplink traffic or downlink traffic associated with the respective logical channel.

In a sixth aspect, alone or in combination with one or more of the first through fifth aspects, the MAC-CE is a downlink MAC-CE transmitted to the UE that includes, for each of the one or more logical channels, an ABR indication that indicates the estimated ABR for a respective logical channel.

In a seventh aspect, alone or in combination with one or more of the first through sixth aspects, the MAC-CE is an uplink MAC-CE received from the UE that includes, for each of the one or more logical channels, a field to indicate whether the uplink MAC-CE carries an inquiry or an indication related to the estimated ABR for a respective logical channel.

In an eighth aspect, alone or in combination with one or more of the first through seventh aspects, the uplink MAC-CE includes, in a field carrying an inquiry related to the estimated ABR for a logical channel among the one or more logical channels, an indicated frame rate to inquire about the estimated ABR for the logical channel at the indicated frame rate.

In a ninth aspect, alone or in combination with one or more of the first through eighth aspects, the uplink MAC-CE indicates, in one or more fields carrying an indication related to the estimated ABR for a logical channel among the one or more logical channels, the frame rate and the bit rate to be used for the traffic associated with the logical channel.

In a tenth aspect, alone or in combination with one or more of the first through ninth aspects, the information related to the estimated ABR is signaled in UAI received from the UE.

In an eleventh aspect, alone or in combination with one or more of the first through tenth aspects, the UAI indicates that a message carrying the UAI is an inquiry about the estimated ABR for the one or more logical channels, indicates the one or more logical channels associated with the inquiry, and indicates a target frame rate for the one or more logical channels associated with the inquiry.

In a twelfth aspect, alone or in combination with one or more of the first through eleventh aspects, the UAI indicates that a message carrying the UAI is a rate indication for the one or more logical channels, indicates a new value for one or more of the frame rate or the bit rate to be used for the traffic associated with the one or more logical channels, and indicates when the new value will become effective.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

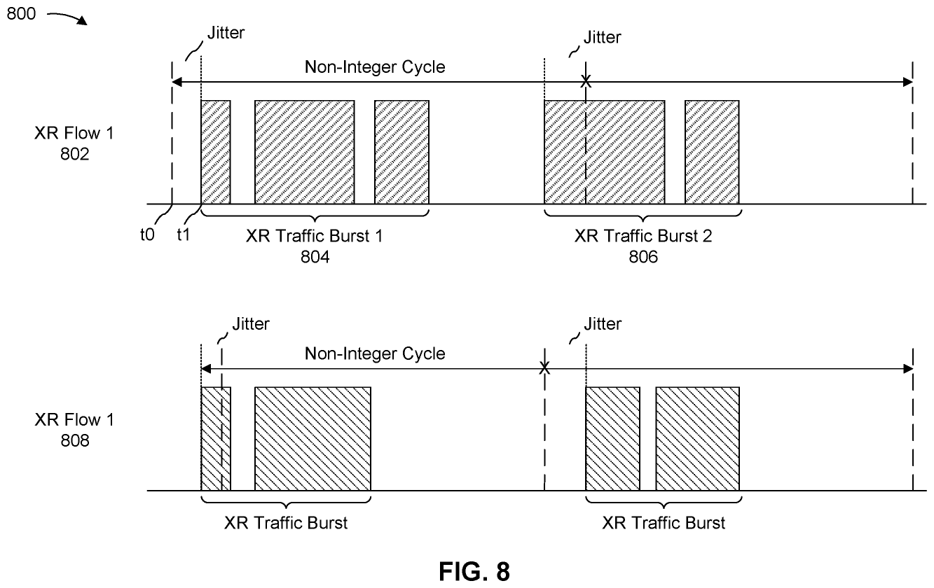

FIG. 8 is a diagram illustrating examples 800 of XR traffic, in accordance with the present disclosure. As described herein, XR traffic may refer to wireless communications for technologies such as VR, MR, and/or AR. VR may refer to technologies in which a user is immersed in a simulated experience that is similar or different from the real world. A user may interact with a VR system through a VR headset or a multi-projected environment that generates realistic images, sounds, and other sensations that simulate physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a network node and received by a UE or the XR traffic may be transmitted by a UE and received by a network node.

XR traffic may arrive in periodic traffic bursts (“XR traffic bursts”). An XR traffic burst may vary in a number of packets per burst and/or a size of each pack in the burst. For example, FIG. 8 illustrates a first XR flow 802 that includes a first XR traffic burst 804 and a second XR traffic burst 806. As shown in FIG. 8, the traffic bursts may include different numbers of packets (e.g., the first XR traffic burst 804 is shown with three packets, represented as rectangles, and the second XR traffic burst 806 is shown with two packets). Furthermore, as illustrated in FIG. 8, the three packets in the first XR traffic burst 804 and the two packets in the second XR traffic burst 806 may vary in size. For example, packets within the first XR traffic burst 804 and packets within the second XR traffic burst 806 may include varying amounts of data.

XR traffic bursts may arrive at non-integer periods (e.g., in a non-integer cycle). The periods may be different than an integer number of symbols, slots, or other transmission time intervals (TTIs). In an example, for 60 FPS video data, XR traffic bursts may arrive in 1/60=16.67 millisecond (ms) periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a network node) expects the XR traffic bursts. As described herein, the variability of the packet arrival relative to the period (e.g., 16.76 ms period, 8.33 ms period, or the like) may be referred to as jitter. In an example, jitter for XR traffic may range from −4 ms (earlier than expected arrival) to +4 ms (later than expected arrival). For instance, referring to the first XR flow 802, a UE may expect a first packet of the first XR traffic burst 804 to arrive at time to, but the first packet of the first XR traffic burst 804 arrives at time t1.

XR traffic may include multiple flows that arrive at a UE (or a network node) concurrently with one another (or within a threshold period of time). For instance, the second XR flow 808 shown in FIG. 8 may have different characteristics than the first XR flow 802. For instance, the second XR flow 808 may have XR traffic bursts with different numbers of packets, different sizes of packets, or other characteristics that vary from the first XR flow 802. In an example, the first XR flow 802 may include video data and the second XR flow 808 may include audio data for the video data. In another example, the first XR flow 802 may include intra-coded picture frames (I-frames) that include complete images and the second XR flow 808 may include predicted picture frames (P-frames) that include changes from a previous image.

XR traffic may have an associated packet delay budget (PDB). If a packet does not arrive within the PDB, a UE (or a network node) may discard the packet. In an example, if a packet corresponding to a video frame of a video does not arrive at a UE within a PDB, the UE may discard the packet, as the video has advanced beyond the frame.

In general, XR traffic may be characterized by relatively high data rates and low latency. The latency in XR traffic may affect the user experience. For instance, XR traffic may have applications in enhanced mobile broadband (eMBB) and ultra-reliable low-latency communication (URLLC) services.

Some types of wireless communication systems may employ dynamic grants for scheduling purposes to accommodate traffic (e.g., XR traffic). In a dynamic grant, a scheduler may use control signaling to allocation resources for transmission or reception at a UE (e.g., a grant of uplink or downlink resources). Dynamic grants may be flexible and can adopt to variations in traffic behavior. A UE may monitor for a physical downlink control channel (PDCCH) including downlink control information (DCI) that schedules the UE to transmit or receive communication with a network node (e.g., instructions to receive data over a physical downlink shared channel (PDSCH)). However, monitoring for a PDCCH consumes power at the UE, and can increase latency in communication between the UE and the network node as the UE waits for a resource assignment to transmit or receive communication.

Various aspects may be employed to provide power saving and/or capacity improvement for wireless communication (e.g., including XR traffic). In some aspects, scheduling mechanisms such as SPS or a configured grant (CG) may be used to provide periodic resources for uplink or downlink communication that can be used without a dynamic grant of resources. The SPS or CG scheduling may be configured to accommodate the periodic traffic, multiple flows, jitter, latency, and reliability for the wireless traffic and may improve capacity and/or latency for such wireless communication. In some aspects, DRX or other power saving configurations may be used to save power at the UE and accommodate periodic traffic, multiple flows, jitter, latency, and reliability for the wireless traffic such as XR traffic, among other examples.

As indicated above, FIG. 8 is provided as an example. Other examples may differ from what is described with regard to FIG. 8.

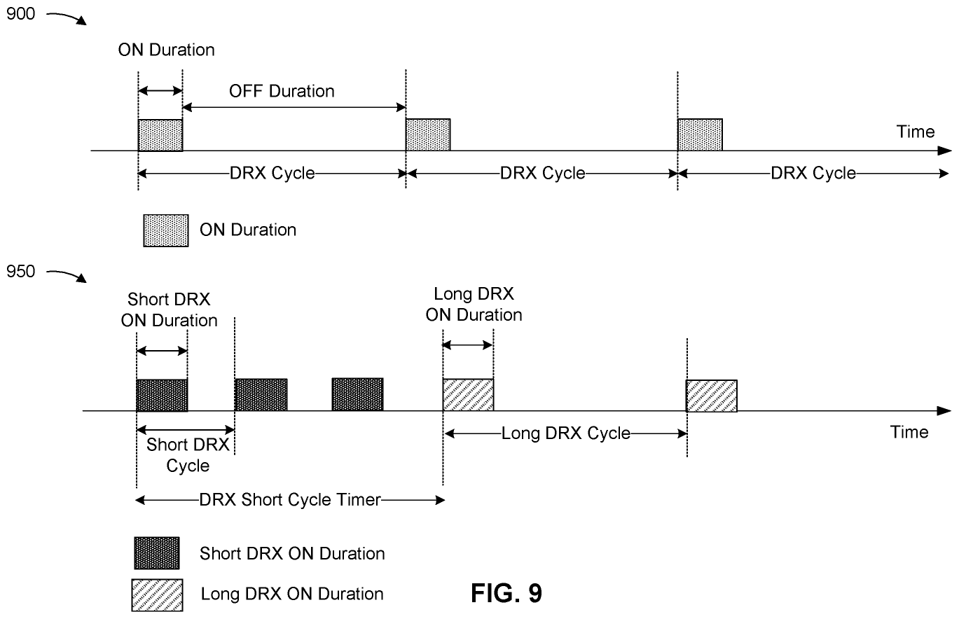

FIG. 9 is a diagram illustrating examples 900 and 950 of DRX configurations, in accordance with the present disclosure. In some aspects, a UE may receive a DRX configuration from a network node. For example, in an RRC connected state, when there is no data transmission in either an uplink direction or a downlink direction, the UE may operate using a DRX mode based on the DRX configuration provided by the network node. In the DRX mode, the UE may monitor a PDCCH discontinuously using a sleep and wake cycle (e.g., OFF durations and ON durations). When the UE is in an RRC connected state, the DRX may also be referred to as connected mode DRX (C-DRX). DRX conserves battery power at the UE. In a non-DRX mode, the UE monitors for a PDCCH in each subframe to check whether there is downlink data available. Continuous monitoring of the PDCCH uses more battery power at the UE.

The UE may receive the DRX configuration from the network node in RRC signaling, such as an RRC connection setup request message or an RRC connection reconfiguration request message. A DRX configuration may configure one or more timers and/or values. In some examples, the DRX configuration may include an ON duration timer, a DRX inactivity timer, a DRX retransmission timer, a DRX uplink retransmission timer, a long DRX cycle, a value of a DRX start offset, a DRX short cycle timer, and/or a short DRX cycle, among others. A DRX cycle may include a periodic repetition of an ON duration in which the UE monitors for a PDCCH from the network node and an OFF duration in which the UE does not monitor for a PDCCH from the network node. For example, FIG. 9 depicts an example 500 of a DRX cycle that includes periodic ON durations during which the UE monitors for PDCCH and OFF durations during which the UE may refrain from monitoring for the PDCCH. The OFF duration may be referred to as a DRX opportunity. During the OFF duration, the UE does not monitor for a PDCCH. The UE may enter a sleep mode or a low power mode in which the UE minimizes power consumption by shutting down an RF function without detecting communication from the network node.

The ON duration timer may correspond to a number of consecutive PDCCH subframes to be monitored or decoded when the UE wakes up from the OFF duration in the DRX cycle. The DRX retransmission timer may correspond to a consecutive number of PDCCH subframes for the UE to monitor when a retransmission is expected by the UE. The DRX inactivity timer may correspond to an amount of time before the UE may again enter the OFF duration following a successful PDCCH decoding. The amount of time may be in terms of a TTI duration (e.g., a number of frames, slots, and/or symbols). After a UE successfully receives downlink data, the DRX inactivity timer may start counting a number of subframes. If any uplink or downlink data transmissions occur while the DRX inactivity timer is running, the timer restarts. If the DRX inactivity timer expires without uplink or downlink activity, the UE may enter the DRX cycle to achieve power savings. The UE may start with a short DRX cycle.

The DRX short cycle may correspond to a first DRX cycle that the UE enters after successful expiration of the DRX inactivity timer. FIG. 9 illustrates an example 950 showing a DRX short cycle. The UE may operate using the short DRX cycle until a DRX short cycle timer expires. Once the DRX short cycle expires, the UE may enter a long DRX cycle. The example 950 also illustrates an example DRX long cycle. A DRX short cycle timer may correspond to a number of consecutive subframes during which the UE follows the short DRX cycle after the DRX inactivity timer has expired. The UE may further be able to transition to an idle mode DRX based on an RRC inactivity timer.

As indicated above, FIG. 9 is provided as an example. Other examples may differ from what is described with regard to FIG. 9.

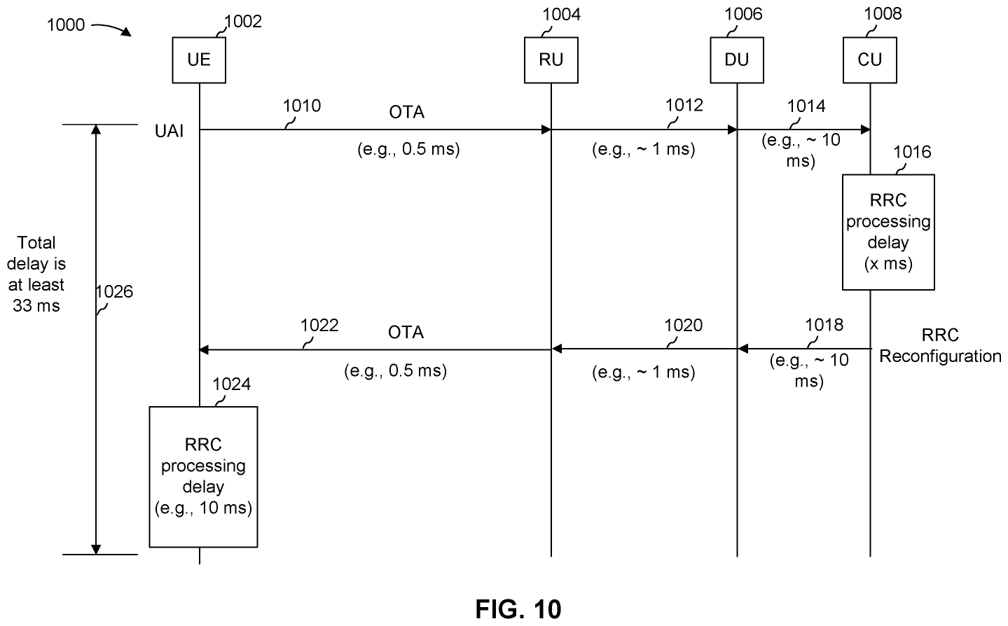

FIG. 10 is a diagram illustrating an example communication flow for UAI that a UE may provide to a network to trigger a reconfiguration based on a change in traffic parameters, in accordance with the present disclosure.

In some cases, a change in traffic for a UE may trigger a reconfiguration. For example, in some cases, a UE may be provided with one or more configurations that may be associated with a traffic parameter of the UE, such as a DRX configuration (e.g., as described above with respect to FIG. 9) that may depend on a frame rate.

As another example configuration, a network node may provide a UE with an SPS or a CG configuration that may depend on a bit rate and/or a frame rate. A CG configuration may be received, for example, in RRC signaling and may provide the UE with recurring resources that are allocated for transmission or reception. For example, rather than a UE requesting uplink resources (e.g., by transmitting a scheduling request (SR), a buffer status report (BSR), or otherwise indicating that the UE has uplink traffic to transmit and then receiving DCI allocating or scheduling resources for the uplink transmission), the network node may pre-allocate resources for the UE to use for uplink transmission. Whereas dynamically scheduling uplink transmissions may be based on resources allocated in DCI, the CG resources may be used by the UE based on the RRC configuration and without receiving an additional allocation in DCI. In some aspects, a CG configuration that is RRC-configured may be activated by a MAC-CE. In other cases, the CG configuration may be used based on the RRC configuration and without activation via a MAC-CE. In SPS-based resource allocation, a network node allocates resources to a UE semi-statically for a particular time interval. The UE may use the pre-allocated resources for transmission or reception for the particular time interval.

Another example of a configuration that may be provided to a UE is a logical channel prioritization (LCP) configuration. When a UE receives an uplink grant from a network node, the UE determines how to use (e.g., split) the granted resources for data from different logical channels. The UE may be configured with multiple logical channels (LCHs) and may have data associated with one or more of the LCHs for transmission at a time when the UE has an allocation of uplink resources. The UE may use an LCP procedure to share resources for uplink transmission among LCHs. The LCP procedure may control how uplink shared channel (UL-SCH) resources are shared among the LCHs, for example. The LCHs may be served based on different priorities among the LCHs. Each of the LCHs may be configured with a scheduling priority, and data packets from the different LCHs may be scheduled in uplink resources based on the scheduling priority of the corresponding LCH associated with the data packets. For example, packets for a higher priority LCH may be scheduled prior to packets from a lower priority LCH. In some aspects, the priority based LCP may be referred to as being based on strict priority (e.g., in which the LCH with the highest priority is served first, and the LCH of the second highest priority is not served until the LCH with the highest priority no longer has buffered data). Similarly, the LCH with a priority lower than the second highest priority is not served until the LCH with highest priority and the LCH with the second highest priority no longer have buffered data.

Some applications may generate multiple types of uplink flows of data. Different flows may have different timing deadlines. For example, different data flows for the same application may have different PDBs. For example, an application that has different data flows with different PDBs may be an XR application (e.g., or similarly a VR application or an AR application) or a different type of cloud-type gaming application. In an XR example, the XR application may generate pose or control packets of information that may have a PDB of 4 ms, and which may arrive for transmission (e.g., be generated) with a period of 10 ms. Such pose data may be based on movement of a user's head, a user's field of vision, or other factors. For example, the application may sample the head position every 10 ms and generate an update to send to the other end of the application (e.g., a cloud-based server). The XR application may also generate hand gesture tracking information to track movement of a player's hand, which may have a longer PDB of 10 ms and may arrive for transmission every 40 ms (e.g., with a period of 40 ms). The XR application may generate voice or audio for transmission, which may have a longer delay budget of 15 ms and may arrive for transmission with a period of 20 ms. In this example, the XR application may generate different flows of traffic that may have different PDB s and different generation periods.

Accordingly, when a UE changes traffic parameters, one or more configurations (e.g., DRX, SPS, CG, and/or LCP configurations) associated with the UE may need to be adapted. For example, FIG. 10 illustrates an example 1000 of a communication flow for UAI that a UE 1002 may provide to a network (e.g., RU 1004, DU 1006, and/or CU 1008) and a corresponding delay. FIG. 10 illustrates a time for the UE 1002 to transmit the UAI in an OTA signal 1010 (e.g., about 0.5 ms), a time for the RU 1004 to provide the information to the DU 1006 at 1012 (e.g., about 1 ms), and a he time for the DU 1006 to provide the information to the CU 1008 at 1014 (e.g., about 10 ms). An RRC processing delay (e.g., x ms) occurs at 1016, before the CU 1008 provides an RRC reconfiguration to the DU 1006, at 1018. FIG. 10 further illustrates a time for the DU 1006 to provide the RRC reconfiguration to the RU 1004 at 1020 (e.g., about 1 ms), and the time for the RU 1004 to transmit an OTA signal 1022 to the UE 1002 (e.g., about 0.5 ms). Then, there is an RRC processing delay 1024 at the UE 1002 (e.g., about 10 ms) before the RRC reconfiguration is applied. As illustrated at 1026, the total delay between the UE transmitting the UAI to the network and the UE 1002 applying the RRC reconfiguration may be 33 ms or longer.

In some aspects, the UE 1002 may inform the network of updated traffic parameters (e.g., a new frame rate, bit rate, and/or burst size) in the UAI. In some aspects, the UE 1002 may request a preferred configuration based on an updated traffic parameter. For example, the UE 1002 may request a CG configuration, a DRX configuration, or another power saving configuration, such as a number of carriers. For example, if the XR traffic includes a continuous feed of video traffic between the UE 1002 and the network, the UE 1002 may experience better power saving if a DRX cycle aligns with the periodic XR traffic (e.g., with the DRX OFF period being between video frames). The delay illustrated in FIG. 10 (e.g., 33 ms or more) may be too long for XR applications. For example, a period of XR traffic may be 1116 ms, and an RRC reconfiguration may take multiple traffic cycles to complete before the UE 1002 can apply the reconfiguration. Video and/or audio traffic may be sensitive to a delay. Some aspects described herein provide L1/L2 signaling to enable faster reconfiguration of a UE in response to changes in traffic at the UE.

As indicated above, FIG. 10 is provided as an example. Other examples may differ from what is described with regard to FIG. 10.

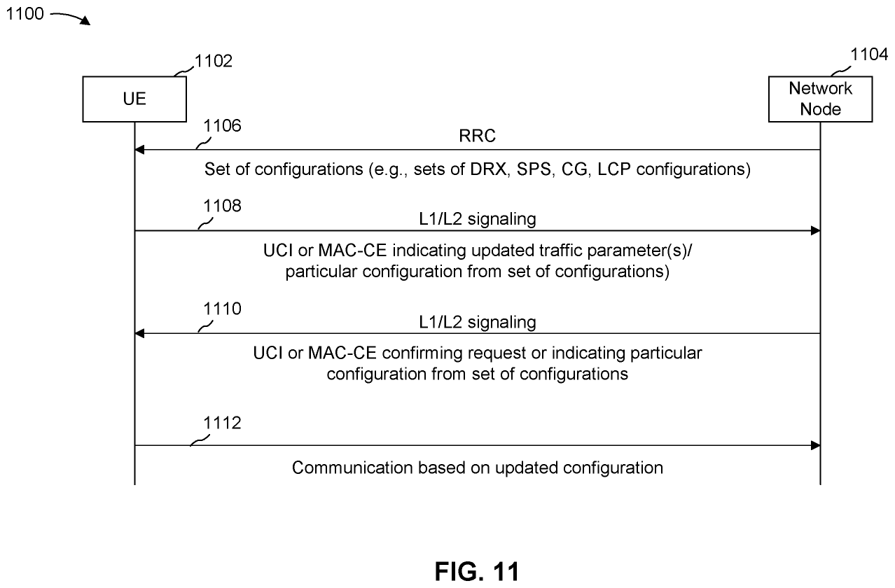

FIG. 11 is a diagram illustrating an example 1100 of a communication flow using L1/L2 signaling to enable faster reconfiguration of a UE in response to changes in traffic at the UE, in accordance with the present disclosure. As shown in FIG. 11, the communication flow may include communication between a UE 1102 and a network node 1104. Although a network node 1104 is illustrated, the communication may be with one or more component of a network node, such as an RU, DU, and/or CU, such as illustrated in FIG. 10. In some aspects, the network node 1104 may configure the UE 1102 with a set of configurations 1106 (e.g., such as a DRX configuration, an SPS configuration, a CG configuration, or an LCP configuration, among other examples). Each configuration in the set corresponds to one of a frame rate and/or a bit rate that the UE 1102 supports.

In some aspects, at 1108, the UE 1102 may then send its new frame rate or bit rate to the network node 1104 in L1 or L2 signaling, such as an uplink MAC-CE or uplink control information (UCI). The network node 1104 then uses either L1 signaling (e.g., DCI) or L2 signaling (e.g., a downlink MAC-CE) to inform the UE 1102 to use one of the DRX, SPS, CG, or LCP configurations previously configured for the UE 1102.

In some aspects, at 1108, the UE 1102 may send L1 or L2 signaling, such as UCI or an uplink MAC-CE, to the network node 1104 to directly indicate one of the configurations in the set that the UE 1102 prefers to use. As an example, the UE 1102 may transmit an index for the configuration that is being requested. As shown, at 1110, the network node 1104 may then respond with an indication (e.g., either L1 signaling, such as DCI, or L2 signaling, such as a downlink MAC-CE) for the UE 1102 to use one of the DRX, SPS, CG, or LCP configurations previously configured for the UE 1102 (e.g., the DRX, SPS, CG, or LCP configuration(s) that were RRC-configured at 1106). If the network node 1104 confirms the request provided by the UE 1102, the network node 1104 may send back the same index as the one requested by UE 1102. If the network node 1104 rejects the request provided by the UE 1102 or determines that the UE 1102 is to use a configuration different from the one requested by the UE 1102, the network node 1104 may respond to the UE 1102 with an index corresponding to a different configuration to be used by the UE 1102.

Then, at 1112, the UE 1102 and the network node 1104 may exchange communication based on the updated configuration. As an example, the UE 1102 may transmit uplink XR traffic to the network node 1104 based on the updated configuration.

The same signaling message from the network node 1104 may have the same format if the UE 1102 sends updated parameters or if the UE 1102 sends a request for a particular configuration.

The request for a particular configuration may enable the UE 1102 to trigger a reconfiguration for reasons other than changes in a particular parameter, such as a frame rate, an encoding rate, a bit rate, or a burst size.

In some aspects, the L1/L2 signaling (e.g., at 1108 or 1110) may indicate a delta on top of a configuration configured by L3 signaling (e.g., an RRC configuration). For example, the L1/L2 signaling may indicate a delta, or an additional configuration, to be applied on top or in combination with the configuration provided in RRC signaling. As an example, the network node 1104 may provide an RRC configuration with DRX parameters, and may preconfigure a set of long DRX cycles. The network node 1104 may then use L1/L2 signaling to change the long DRX cycle for the UE 1102. The long DRX cycle indicated to the UE 1102 in the L1/L2 signaling may override the DRX long cycle value configured by RRC signaling for the UE 1102. Then, the UE 1102 may apply the other previously configured DRX parameters with the DRX long cycle indicated in the L1/L2 signaling.

In some aspects, the L1/L2 reconfigurations (e.g., at 1110) may be semi-static, and the network node 1104 can use an RRC reconfiguration to adjust the sets of configurations that are included in the pre-configuration set.

In some aspects, at 1106, the network node 1104 may provide configurations for a set of DRX configurations. DRX parameters in the configurations may include one or more of a long DRX cycle, a short DRX cycle, a DRX short cycle timer, a DRX inactivity timer, and/or a DRX ON duration. The configurations may be received by the UE 1102 in RRC signaling. Each configuration in the set of configurations (which may be referred to as pre-configurations) may be a selected combination of the above parameters in specific values. As an example, a first configuration (e.g., which may be referred to as “pre-configuration #1”), for example, a DRX configuration provided in RRC signaling, at 1106, may include a long DRX cycle=16 ms, a DRX inactivity timer=8 ms, and a DRX on duration=4 ms. A second configuration (e.g., pre-configuration #2) may include a long DRX cycle=16 ms and a DRX inactivity timer=4 ms. Each configuration (or pre-configuration) may have an associated index. The index may be used by the UE 1102 to indicate a requested configuration at 1108 and/or by the network node 1104 to indicate a selected configuration at 1110. In the example in FIG. 11, the UE 1102 may indicate one or more changed traffic parameters that triggers a selection of pre-configuration #1 or pre-configuration #2. Alternately, the UE 1102 may transmit a request for pre-configuration #1 or pre-configuration #2. The network node 1104 may respond by transmitting L1/L2 signaling, at 1110, that includes an index for either pre-configuration #1 or pre-configuration #2. The UE 1102 may then apply the DRX configuration indicated in the L1/L2 signaling.

In some aspects, the network node 1104 may provide configurations for a set of SPS configurations or a set of CG configurations, at 1106. The configurations may include parameters including one or more of a periodicity, a number of hybrid automatic repeat request (HARQ) processes, an MCS table, a HARQ codebook, a PDSCH and/or physical uplink shared channel (PUSCH) aggregation factor, or a number of MIMO layers. Each pre-configuration can be a selected combination of the above parameters in specific values. For example, pre-configuration #1 may include a periodicity=16 ms, a number of HARQ process=3, and an aggregation factor=4. Pre-configuration #2 may include a periodicity=11 ms, a number of HARQ process=2, and an aggregation factor=2. As described for the example with a set of DRX configurations, each pre-configuration may have an associated index, which may be used at 1108 and/or 1110. In some aspects, the RRC-configured set of CG configurations may include a Type-1 CG. There may be a limited number of SPS/CG configurations that a network can configure. As described herein, different combinations of SPS/CG parameters can allow for much more than the maximum number of configurable SPS/CG configurations. In some aspects, the RRC-configured set of configurations may be LCP configurations, with each pre-configuration including one or more of a logical channel priority, a prioritized bit rate, a bucket size duration, or a list of allowed serving cells, among other examples.

As indicated above, FIG. 11 is provided as an example. Other examples may differ from what is described with regard to FIG. 11.

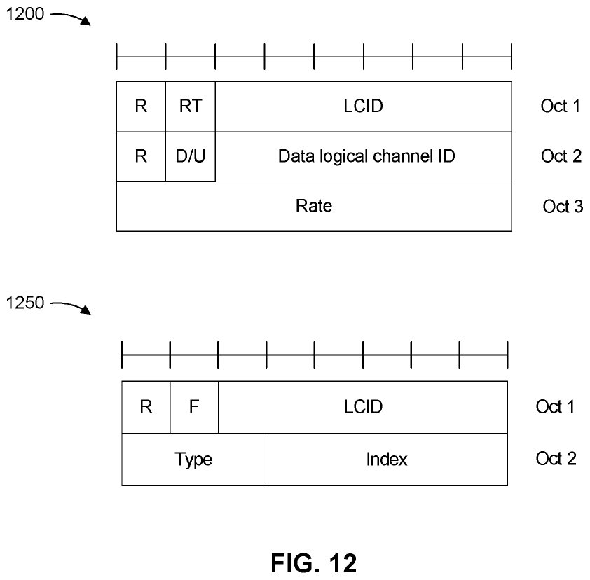

FIG. 12 is a diagram illustrating examples 1200, 1250 of L2 signaling to enable faster reconfiguration of a UE in response to changes in traffic at the UE, in accordance with the present disclosure.

For example, FIG. 12 illustrates an example 1200 of a MAC-CE that a UE (e.g., UE 120 or UE 1102) may transmit to a network node (e.g., network node 110 or network node 1104) to indicate an updated traffic parameter, such as an updated XR traffic parameter. The fields in FIG. 12 that are marked with an “R” are reserved fields. The RT field (e.g., in octet 1) may indicate a type of rate that is being indicated (e.g., a frame rate, an encoding rate, a bit rate, a burst size, or the like). The D/U field (e.g., in octet 2) may indicate whether the new rate is for uplink traffic or downlink traffic. The data logical channel ID field (e.g., in octet 2) may indicate a data logical channel for which the traffic parameter applies (e.g., based on LCID, which may be indicated in octet 1). The rate field (e.g., in octet 3) may include a value of a rate (e.g., for the frame rate, encoding rate, bit rate, or burst size).

Additionally, or alternatively, example 150 depicts a MAC-CE that a UE may transmit to a network node to request a particular configuration, and/or that the network node may transmit to the UE to indicate a particular configuration for the UE to use. The “R” field (e.g., in octet 1) may correspond to a reserved field. The type field (e.g., in octet 2) may indicate the type of configuration (e.g., a previous RRC configuration). For example, the type may be a DRX configuration, an SPS configuration, a CG configuration, or an LCP configuration, among other examples. The index field (e.g., in octet 2) indicates the corresponding index of an RRC-configured configuration (e.g., that is being requested by the UE, if the MAC-CE is sent by the UE, or that is being indicated by the network node, if the MAC-CE is set by the network node).

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120, UE 1002, UE 1102, or the like) performs operations associated with using L1/L2 signaling to enable faster reconfiguration of the UE in response to changes in traffic at the UE.

As shown in FIG. 13, in some aspects, process 1300 may include receiving, from a network entity, a configuration for wireless communication at the UE (block 1310). For example, the UE (e.g., using reception component 1502 and/or communication manager 140, depicted in FIG. 15) may receive, from a network entity, a configuration for wireless communication at the UE, as described above.

As further shown in FIG. 13, in some aspects, process 1300 may include receiving, from the network entity, multiple sets of parameters for the configuration (block 1320). For example, the UE (e.g., using reception component 1502 and/or communication manager 140, depicted in FIG. 15) may receive, from the network entity, multiple sets of parameters for the configuration, as described above.

As further shown in FIG. 13, in some aspects, process 1300 may include L1 or L2 signaling indicating, in response to a change in a traffic pattern at the UE, an updated traffic parameter or a set of parameters from the multiple sets of parameters (block 1330). For example, the UE (e.g., using transmission component 1504 and/or communication manager 140, depicted in FIG. 15) may transmit L1 or L2 signaling indicating, in response to a change in a traffic pattern at the UE, an updated traffic parameter or a set of parameters from the multiple sets of parameters, as described above.

As further shown in FIG. 13, in some aspects, process 1300 may include receiving, from the network entity, an indication to use one of the multiple sets of parameters (block 1340). For example, the UE (e.g., using reception component 1502 and/or communication manager 140, depicted in FIG. 15) may receive, from the network entity, an indication to use one of the multiple sets of parameters, as described above.

As further shown in FIG. 13, in some aspects, process 1300 may include communicating with the network entity based on the configuration and the one of the multiple sets of parameters (block 1350). For example, the UE (e.g., using reception component 1502, transmission component 1504, and/or communication manager 140, depicted in FIG. 15) may communicate with the network entity based on the configuration and the one of the multiple sets of parameters, as described above.

Process 1300 may include additional aspects, such as any single aspect or any combination of aspects described below and/or in connection with one or more other processes described elsewhere herein.

In a first aspect, the traffic pattern is for XR traffic.

In a second aspect, alone or in combination with the first aspect, the L1 or L2 signaling indicates the updated traffic parameter.

In a third aspect, alone or in combination with one or more of the first and second aspects, the updated traffic parameter includes one or more of a frame rate, a bit rate, or a burst size.

In a fourth aspect, alone or in combination with one or more of the first through third aspects, the L1 or L2 signaling indicates the set of parameters from the multiple sets of parameters.

In a fifth aspect, alone or in combination with one or more of the first through fourth aspects, the indication from the network entity indicates for the UE to use the set of parameters indicated by the UE in the L1 or L2 signaling.

In a sixth aspect, alone or in combination with one or more of the first through fifth aspects, the indication from the network entity indicates for the UE to set a different set of parameters than the set of parameters indicated by the UE in the L1 or L2 signaling.

In a seventh aspect, alone or in combination with one or more of the first through sixth aspects, the L1 or L2 signaling indicates a type of preconfigured sets of parameters and an index corresponding to the set of parameters from the multiple sets of parameters configured by the network entity.

In an eighth aspect, alone or in combination with one or more of the first through seventh aspects, the L1 or L2 signaling includes an uplink MAC-CE, and the indication from the network entity is comprised in a downlink MAC-CE or DCI.

In a ninth aspect, alone or in combination with one or more of the first through eighth aspects, the L1 or L2 signaling includes UCI, and the indication from the network entity is comprised in DCI.

In a tenth aspect, alone or in combination with one or more of the first through ninth aspects, the one of the multiple sets of parameters indicated by the network entity changes one or more parameters in the configuration.

In an eleventh aspect, alone or in combination with one or more of the first through tenth aspects, the indication of the one of the multiple sets corresponds to a semi-static reconfiguration of the configuration previously received from the network entity.

In a twelfth aspect, alone or in combination with one or more of the first through eleventh aspects, the configuration is a DRX configuration, and each of the multiple sets of parameters includes one or more of a DRX long cycle parameter, a DRX short cycle parameter, a DRX short cycle timer, a DRX inactivity timer, or a DRX ON duration.

In a thirteenth aspect, alone or in combination with one or more of the first through twelfth aspects, the configuration is an SPS configuration or a CG configuration, and each of the multiple sets of parameters includes one or more of a periodicity, a number of HARQ processes, an MCS table, a HARQ codebook, a PDSCH aggregation factor, a PUSCH aggregation factor, or a number of layers.

In a fourteenth aspect, alone or in combination with one or more of the first through thirteenth aspects, the configuration is an LCP configuration, and each of the multiple sets of parameters includes one or more of a logical channel priority, a prioritized bit rate, a bucket size duration, or a list of allowed serving cells.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., network node 110, network node 1104, or the like) performs operations associated with using L1/L2 signaling to enable faster reconfiguration of a UE in response to changes in traffic at the UE.

As shown in FIG. 14, in some aspects, process 1400 may include configuring a UE with a configuration for wireless communication at the UE (block 1410). For example, the network entity (e.g., using transmission component 1604, configuration adaptation component 1610, and/or communication manager 150, depicted in FIG. 16) may configure a UE with a configuration for wireless communication at the UE, as described above.

As further shown in FIG. 14, in some aspects, process 1400 may include configuring the UE with multiple sets of parameters for the configuration (block 1420). For example, the network entity (e.g., using transmission component 1604, configuration adaptation component 1610, and/or communication manager 150, depicted in FIG. 16) may configure the UE with multiple sets of parameters for the configuration, as described above.

As further shown in FIG. 14, in some aspects, process 1400 may include receiving L1 or L2 signaling indicating, in response to a change in a traffic pattern at the UE, an updated traffic parameter or a set of parameters from the multiple sets of parameters (block 1430). For example, the network entity (e.g., using reception component 1602 and/or communication manager 150, depicted in FIG. 16) may receive L1 or L2 signaling indicating, in response to a change in a traffic pattern at the UE, an updated traffic parameter or a set of parameters from the multiple sets of parameters, as described above.

As further shown in FIG. 14, in some aspects, process 1400 may include providing the UE with an indication to use one of the multiple sets of parameters (block 1440). For example, the network entity (e.g., using transmission component 1604, configuration adaptation component 1610, and/or communication manager 150, depicted in FIG. 16) may provide the UE with an indication to use one of the multiple sets of parameters, as described above.

As further shown in FIG. 14, in some aspects, process 1400 may include communicating with the UE based on the configuration and the one of the multiple sets of parameters (block 1450). For example, the network entity (e.g., using reception component 1602, transmission component 1604, and/or communication manager 150, depicted in FIG. 16) may communicate with the UE based on the configuration and the one of the multiple sets of parameters, as described above.

Process 1400 may include additional aspects, such as any single aspect or any combination of aspects described below and/or in connection with one or more other processes described elsewhere herein.

In a first aspect, the L1 or L2 signaling indicates the updated traffic parameter, wherein the updated traffic parameter includes one or more of a frame rate, a bit rate, or a burst size.

In a second aspect, alone or in combination with the first aspect, the L1 or L2 signaling indicates the set of parameters from the multiple sets of parameters.

In a third aspect, alone or in combination with one or more of the first and second aspects, the L1 or L2 signaling indicates a type of preconfigured sets of parameters and an index corresponding to the set of parameters from the multiple sets of parameters configured by the network entity.

In a fourth aspect, alone or in combination with one or more of the first through third aspects, the L1 or L2 signaling includes an uplink MAC-CE, and the indication from the network entity is comprised in a downlink MAC-CE or DCI.

In a fifth aspect, alone or in combination with one or more of the first through fourth aspects, the L1 or L2 signaling includes UCI, and the indication from the network entity is comprised in DCI.

In a sixth aspect, alone or in combination with one or more of the first through fifth aspects, the one of the multiple sets of parameters indicated by the network entity changes one or more parameters in the configuration.

In a seventh aspect, alone or in combination with one or more of the first through sixth aspects, the indication of the one of the multiple sets corresponds to a semi-static reconfiguration of the configuration from the network entity.

In an eighth aspect, alone or in combination with one or more of the first through seventh aspects, the configuration is a DRX configuration, and each of the multiple sets of parameters includes one or more of a DRX long cycle parameter, a DRX short cycle parameter, a DRX short cycle timer, a DRX inactivity timer, or a DRX ON duration.

In a ninth aspect, alone or in combination with one or more of the first through eighth aspects, the configuration is an SPS configuration or a CG configuration, and each of the multiple sets of parameters includes one or more of a periodicity, a number of HARQ processes, an MCS table, a HARQ codebook, a PDSCH aggregation factor, a PUSCH aggregation factor, or a number of layers.

In a tenth aspect, alone or in combination with one or more of the first through ninth aspects, the configuration is an LCP configuration, and each of the multiple sets of parameters includes one or more of a logical channel priority, a prioritized bit rate, a bucket size duration, or a list of allowed serving cells.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. As further shown, the communication manager 140 may include a traffic processing component 1508 and/or an adaptation component 1510, among other examples.

In some aspects, the apparatus 1500 may be configured to perform one or more operations described herein in connection with FIGS. 4-5 and/or FIGS. 11-12. Additionally, or alternatively, the apparatus 1500 may be configured to perform one or more processes described herein, such as process 600 of FIG. 6 and/or process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 and/or the transmission component 1504 may communicate with a network entity to signal information related to an estimated ABR for each of one or more logical channels on at least one of an uplink or a downlink. The traffic processing component 1508 may communicate traffic associated with the one or more logical channels according to a frame rate or a bit rate that is based at least in part on the information related to the estimated ABR for the one or more logical channels.

The reception component 1502 may receive, from the network entity, downlink signaling including an ABR indication for the one or more logical channels.

The transmission component 1504 may transmit, to the network entity, uplink signaling that includes an ABR inquiry for the one or more logical channels, wherein the ABR indication is based at least in part on the ABR inquiry.

The transmission component 1504 may transmit, to the network entity, uplink signaling that includes a preferred rate indication for the one or more logical channels.

The reception component 1502 may receive, from a network entity, a configuration for wireless communication at the UE. The reception component 1502 may receive, from the network entity, multiple sets of parameters for the configuration. The transmission component 1504 may transmit L1 or L2 signaling indicating, in response to a change in a traffic pattern at the UE, an updated traffic parameter or a set of parameters from the multiple sets of parameters. The reception component 1502 may receive, from the network entity, an indication to use one of the multiple sets of parameters. The reception component 1502, the transmission component 1504, and/or the adaptation component 1510 may communicate with the network entity based on the configuration and the one of the multiple sets of parameters.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network entity, or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 150. As further shown, the communication manager 150 may include a traffic processing component 1608 and/or a configuration adaptation component 1610, among other examples.

In some aspects, the apparatus 1600 may be configured to perform one or more operations described herein in connection with FIGS. 4-5 and/or FIGS. 11-12. Additionally, or alternatively, the apparatus 1600 may be configured to perform one or more processes described herein, such as process 700 of FIG. 7 and/or process 1400 of FIG. 14. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The reception component 1602 and/or the transmission component 1604 may communicate with a UE to signal information related to an estimated ABR for each of one or more logical channels on at least one of an uplink or a downlink. The traffic processing component 1608 may communicate traffic associated with the one or more logical channels according to a frame rate or a bit rate that is based at least in part on the information related to the estimated ABR for the one or more logical channels.

The transmission component 1604 may transmit, to the UE, downlink signaling including an ABR indication for the one or more logical channels.

The reception component 1602 may receive, from the UE, uplink signaling that includes an ABR inquiry for the one or more logical channels, wherein the ABR indication is based at least in part on the ABR inquiry.

The reception component 1602 may receive, from the UE, uplink signaling that includes a preferred rate indication for the one or more logical channels.

The configuration adaptation component 1610 and/or the transmission component 1604 may configure a UE with a configuration for wireless communication at the UE. The configuration adaptation component 1610 and/or the transmission component 1604 may configure the UE with multiple sets of parameters for the configuration. The reception component 1602 may receive L1 or L2 signaling indicating, in response to a change in a traffic pattern at the UE, an updated traffic parameter or a set of parameters from the multiple sets of parameters. The configuration adaptation component 1610 and/or the transmission component 1604 may provide the UE with an indication to use one of the multiple sets of parameters. The reception component 1602 and/or the transmission component 1604 may communicate with the UE based on the configuration and the one of the multiple sets of parameters.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a UE, comprising: communicating with a network entity to signal information related to an estimated ABR for each of one or more logical channels on at least one of an uplink or a downlink; and communicating traffic associated with the one or more logical channels according to a frame rate or a bit rate that is based at least in part on the information related to the estimated ABR for the one or more logical channels.

Aspect 2: The method of Aspect 1, wherein communicating with the network entity to signal the information related to the estimated ABR includes: receiving, from the network entity, downlink signaling including an ABR indication for the one or more logical channels.

Aspect 3: The method of Aspect 2, wherein communicating with the network entity to signal the information related to the estimated ABR further includes: transmitting, to the network entity, uplink signaling that includes an ABR inquiry for the one or more logical channels, wherein the ABR indication is based at least in part on the ABR inquiry.

Aspect 4: The method of Aspect 1, wherein communicating with the network entity to signal the information related to the estimated ABR includes: transmitting, to the network entity, uplink signaling that includes a preferred rate indication for the one or more logical channels.

Aspect 5: The method of any of Aspects 1-4, wherein the information related to the estimated ABR is signaled in a MAC-CE.

Aspect 6: The method of Aspect 5, wherein the MAC-CE includes, for each of the one or more logical channels, an identifier of a respective logical channel and a field that indicates whether the MAC-CE is related to the estimated ABR for uplink traffic or downlink traffic associated with the respective logical channel.

Aspect 7: The method of any of Aspects 5-6, wherein the MAC-CE is a downlink MAC-CE received from the network entity that includes, for each of the one or more logical channels, an ABR indication that indicates the estimated ABR for a respective logical channel.

Aspect 8: The method of any of Aspects 5-6, wherein the MAC-CE is an uplink MAC-CE transmitted to the network entity that includes, for each of the one or more logical channels, a field to indicate whether the uplink MAC-CE carries an inquiry or an indication related to the estimated ABR for a respective logical channel.

Aspect 9: The method of Aspect 8, wherein the uplink MAC-CE includes, in a field carrying an inquiry related to the estimated ABR for a logical channel among the one or more logical channels, an indicated frame rate to inquire about the estimated ABR for the logical channel at the indicated frame rate.

Aspect 10: The method of Aspect 8, wherein the uplink MAC-CE indicates, in one or more fields carrying an indication related to the estimated ABR for a logical channel among the one or more logical channels, the frame rate and the bit rate to be used for the traffic associated with the logical channel.

Aspect 11: The method of any of Aspects 1-4, wherein the information related to the estimated ABR is signaled in UAI transmitted to the network entity.

Aspect 12: The method of Aspect 11, wherein the UAI indicates that a message carrying the UAI is an inquiry about the estimated ABR for the one or more logical channels, indicates the one or more logical channels associated with the inquiry, and indicates a target frame rate for the one or more logical channels associated with the inquiry.

Aspect 13: The method of Aspect 11, wherein the UAI indicates that a message carrying the UAI is a rate indication for the one or more logical channels, indicates a new value for one or more of the frame rate or the bit rate to be used for the traffic associated with the one or more logical channels, and indicates when the new value will become effective.

Aspect 14: A method of wireless communication performed by a network entity, comprising: communicating with a UE to signal information related to an estimated ABR for each of one or more logical channels on at least one of an uplink or a downlink; and communicating traffic associated with the one or more logical channels according to a frame rate or a bit rate that is based at least in part on the information related to the estimated ABR for the one or more logical channels.

Aspect 15: The method of Aspect 14, wherein communicating with the UE to signal the information related to the estimated ABR includes: transmitting, to the UE, downlink signaling including an ABR indication for the one or more logical channels.

Aspect 16: The method of Aspect 15, wherein communicating with the UE to signal the information related to the estimated ABR further includes: receiving, from the UE, uplink signaling that includes an ABR inquiry for the one or more logical channels, wherein the ABR indication is based at least in part on the ABR inquiry.

Aspect 17: The method of Aspect 14, wherein communicating with the UE to signal the information related to the estimated ABR includes: receiving, from the UE, uplink signaling that includes a preferred rate indication for the one or more logical channels.

Aspect 18: The method of any of Aspects 14-17, wherein the information related to the estimated ABR is signaled in a MAC-CE.

Aspect 19: The method of Aspect 18, wherein the MAC-CE includes, for each of the one or more logical channels, an identifier of a respective logical channel and a field that indicates whether the MAC-CE is related to the estimated ABR for uplink traffic or downlink traffic associated with the respective logical channel.

Aspect 20: The method of any of Aspects 18-19, wherein the MAC-CE is a downlink MAC-CE transmitted to the UE that includes, for each of the one or more logical channels, an ABR indication that indicates the estimated ABR for a respective logical channel.

Aspect 21: The method of any of Aspects 18-19, wherein the MAC-CE is an uplink MAC-CE received from the UE that includes, for each of the one or more logical channels, a field to indicate whether the uplink MAC-CE carries an inquiry or an indication related to the estimated ABR for a respective logical channel.

Aspect 22: The method of Aspect 21, wherein the uplink MAC-CE includes, in a field carrying an inquiry related to the estimated ABR for a logical channel among the one or more logical channels, an indicated frame rate to inquire about the estimated ABR for the logical channel at the indicated frame rate.

Aspect 23: The method of Aspect 21, wherein the uplink MAC-CE indicates, in one or more fields carrying an indication related to the estimated ABR for a logical channel among the one or more logical channels, the frame rate and the bit rate to be used for the traffic associated with the logical channel.

Aspect 24: The method of any of Aspects 14-17, wherein the information related to the estimated ABR is signaled in UAI received from the UE.

Aspect 25: The method of Aspect 24, wherein the UAI indicates that a message carrying the UAI is an inquiry about the estimated ABR for the one or more logical channels, indicates the one or more logical channels associated with the inquiry, and indicates a target frame rate for the one or more logical channels associated with the inquiry.

Aspect 26: The method of Aspect 24, wherein the UAI indicates that a message carrying the UAI is a rate indication for the one or more logical channels, indicates a new value for one or more of the frame rate or the bit rate to be used for the traffic associated with the one or more logical channels, and indicates when the new value will become effective.

Aspect 27: A method of wireless communication performed by a UE, comprising: receiving, from a network entity, a configuration for wireless communication at the UE; receiving, from the network entity, multiple sets of parameters for the configuration; transmitting L1 or L2 signaling indicating, in response to a change in a traffic pattern at the UE, an updated traffic parameter or a set of parameters from the multiple sets of parameters; receiving, from the network entity, an indication to use one of the multiple sets of parameters; and communicating with the network entity based on the configuration and the one of the multiple sets of parameters.

Aspect 28: The method of Aspect 27, wherein the traffic pattern is for XR traffic.

Aspect 29: The method of any of Aspects 27-28, wherein the L1 or L2 signaling indicates the updated traffic parameter.

Aspect 30: The method of Aspect 29, wherein the updated traffic parameter includes one or more of a frame rate, a bit rate, or a burst size.

Aspect 31: The method of any of Aspects 27-30, wherein the L1 or L2 signaling indicates the set of parameters from the multiple sets of parameters.

Aspect 32: The method of Aspect 31, wherein the indication from the network entity indicates for the UE to use the set of parameters indicated by the UE in the L1 or L2 signaling.

Aspect 33: The method of Aspect 31, wherein the indication from the network entity indicates for the UE to set a different set of parameters than the set of parameters indicated by the UE in the L1 or L2 signaling.

Aspect 34: The method of any of Aspects 31-33, wherein the L1 or L2 signaling indicates a type of preconfigured sets of parameters and an index corresponding to the set of parameters from the multiple sets of parameters configured by the network entity.

Aspect 35: The method of any of Aspects 27-34, wherein the L1 or L2 signaling includes an uplink MAC-CE, and the indication from the network entity is comprised in a downlink MAC-CE or DCI.

Aspect 36: The method of any of Aspects 27-34, wherein the L1 or L2 signaling includes UCI, and the indication from the network entity is comprised in DCI.

Aspect 37: The method of any of Aspects 27-36, wherein the one of the multiple sets of parameters indicated by the network entity changes one or more parameters in the configuration.

Aspect 38: The method of any of Aspects 27-37, wherein the indication of the one of the multiple sets corresponds to a semi-static reconfiguration of the configuration previously received from the network entity.

Aspect 39: The method of any of Aspects 27-38, wherein the configuration is a DRX configuration, and each of the multiple sets of parameters includes one or more of a DRX long cycle parameter, a DRX short cycle parameter, a DRX short cycle timer, a DRX inactivity timer, or a DRX ON duration.

Aspect 40: The method of any of Aspects 27-38, wherein the configuration is an SPS configuration or a CG configuration, and each of the multiple sets of parameters includes one or more of: a periodicity, a number of HARQ processes, an MCS table, a HARQ codebook, a PDSCH aggregation factor, a PUSCH aggregation factor, or a number of layers.

Aspect 41: The method of any of Aspects 27-38, wherein the configuration is an LCP configuration, and each of the multiple sets of parameters includes one or more of: a logical channel priority, a prioritized bit rate, a bucket size duration, or a list of allowed serving cells.

Aspect 42: A method of wireless communication performed by a network entity, comprising: configuring a UE with a configuration for wireless communication at the UE; configuring the UE with multiple sets of parameters for the configuration; receiving L1 or L2 signaling indicating, in response to a change in a traffic pattern at the UE, an updated traffic parameter or a set of parameters from the multiple sets of parameters; providing the UE with an indication to use one of the multiple sets of parameters; and communicating with the UE based on the configuration and the one of the multiple sets of parameters.

Aspect 43: The method of Aspect 42, wherein the L1 or L2 signaling indicates the updated traffic parameter, wherein the updated traffic parameter includes one or more of a frame rate, a bit rate, or a burst size.

Aspect 44: The method of any of Aspects 42-43, wherein the L1 or L2 signaling indicates the set of parameters from the multiple sets of parameters.

Aspect 45: The method of Aspect 44, wherein the L1 or L2 signaling indicates a type of preconfigured sets of parameters and an index corresponding to the set of parameters from the multiple sets of parameters configured by the network entity.

Aspect 46: The method of any of Aspects 42-45, wherein the L1 or L2 signaling includes an uplink MAC-CE, and the indication from the network entity is comprised in a downlink MAC-CE or DCI.

Aspect 47: The method of any of Aspects 42-45, wherein the L1 or L2 signaling includes UCI, and the indication from the network entity is comprised in DCI.

Aspect 48: The method of any of Aspects 42-47, wherein the one of the multiple sets of parameters indicated by the network entity changes one or more parameters in the configuration.

Aspect 49: The method of any of Aspects 42-48, wherein the indication of the one of the multiple sets corresponds to a semi-static reconfiguration of the configuration from the network entity.

Aspect 50: The method of any of Aspects 42-49, wherein the configuration is a DRX configuration, and each of the multiple sets of parameters includes one or more of a DRX long cycle parameter, a DRX short cycle parameter, a DRX short cycle timer, a DRX inactivity timer, or a DRX ON duration.

Aspect 51: The method of any of Aspects 42-49, wherein the configuration is an SPS configuration or a CG configuration, and each of the multiple sets of parameters includes one or more of: a periodicity, a number of HARQ processes, an MCS table, a HARQ codebook, a PDSCH aggregation factor, a PUSCH aggregation factor, or a number of layers.

Aspect 52: The method of any of Aspects 42-49, wherein the configuration is an LCP configuration, and each of the multiple sets of parameters includes one or more of: a logical channel priority, a prioritized bit rate, a bucket size duration, or a list of allowed serving cells.

Aspect 53: An apparatus for wireless communication at a device, comprising a processor; memory coupled with the processor; and instructions stored in the memory and executable by the processor to cause the apparatus to perform the method of one or more of Aspects 1-52.

Aspect 54: A device for wireless communication, comprising a memory and one or more processors coupled to the memory, the one or more processors configured to perform the method of one or more of Aspects 1-52.

Aspect 55: An apparatus for wireless communication, comprising at least one means for performing the method of one or more of Aspects 1-52.

Aspect 56: A non-transitory computer-readable medium storing code for wireless communication, the code comprising instructions executable by a processor to perform the method of one or more of Aspects 1-52.

Aspect 57: A non-transitory computer-readable medium storing a set of instructions for wireless communication, the set of instructions comprising one or more instructions that, when executed by one or more processors of a device, cause the device to perform the method of one or more of Aspects 1-52.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
communicate with a network entity to signal information related to an estimated available bit rate (ABR) for each of one or more logical channels on at least one of an uplink or a downlink; and
communicate traffic associated with the one or more logical channels according to a frame rate or a bit rate that is based at least in part on the information related to the estimated ABR for the one or more logical channels.

2. The UE of claim 1, wherein the one or more processors, to communicate with the network entity to signal the information related to the estimated ABR, are configured to:
receive, from the network entity, downlink signaling including an ABR indication for the one or more logical channels.

3. The UE of claim 2, wherein the one or more processors, to communicate with the network entity to signal the information related to the estimated ABR, are configured to:
transmit, to the network entity, uplink signaling that includes an ABR inquiry for the one or more logical channels, wherein the ABR indication is based at least in part on the ABR inquiry.

4. The UE of claim 1, wherein the one or more processors, to communicate with the network entity to signal the information related to the estimated ABR, are configured to:
transmit, to the network entity, uplink signaling that includes a preferred rate indication for the one or more logical channels.

5. The UE of claim 1, wherein the information related to the estimated ABR is signaled in a medium access control (MAC) control element (MAC-CE).

6. The UE of claim 5, wherein the MAC-CE includes, for each of the one or more logical channels, an identifier of a respective logical channel and a field that indicates whether the MAC-CE is related to the estimated ABR for uplink traffic or downlink traffic associated with the respective logical channel.

7. The UE of claim 5, wherein the MAC-CE is a downlink MAC-CE received from the network entity that includes, for each of the one or more logical channels, an ABR indication that indicates the estimated ABR for a respective logical channel.

8. The UE of claim 5, wherein the MAC-CE is an uplink MAC-CE transmitted to the network entity that includes, for each of the one or more logical channels, a field to indicate whether the uplink MAC-CE carries an inquiry or an indication related to the estimated ABR for a respective logical channel.

9. The UE of claim 8, wherein the uplink MAC-CE includes, in a field carrying an inquiry related to the estimated ABR for a logical channel among the one or more logical channels, an indicated frame rate to inquire about the estimated ABR for the logical channel at the indicated frame rate.

10. The UE of claim 8, wherein the uplink MAC-CE indicates, in one or more fields carrying an indication related to the estimated ABR for a logical channel among the one or more logical channels, the frame rate and the bit rate to be used for the traffic associated with the logical channel.

11. The UE of claim 1, wherein the information related to the estimated ABR is signaled in UE assistance information (UAI) transmitted to the network entity.

12. The UE of claim 11, wherein the UAI indicates that a message carrying the UAI is an inquiry about the estimated ABR for the one or more logical channels, indicates the one or more logical channels associated with the inquiry, and indicates a target frame rate for the one or more logical channels associated with the inquiry.

13. The UE of claim 11, wherein the UAI indicates that a message carrying the UAI is a rate indication for the one or more logical channels, indicates a new value for one or more of the frame rate or the bit rate to be used for the traffic associated with the one or more logical channels, and indicates when the new value will become effective.

14. A network entity for wireless communication, comprising:
a memory; and
one or more processors, coupled to the memory, configured to:
communicate with a user equipment (UE) to signal information related to an estimated available bit rate (ABR) for each of one or more logical channels on at least one of an uplink or a downlink; and
communicate traffic associated with the one or more logical channels according to a frame rate or a bit rate that is based at least in part on the information related to the estimated ABR for the one or more logical channels.

15. The network entity of claim 14, wherein the one or more processors, to communicate with the UE to signal the information related to the estimated ABR, are configured to:
transmit, to the UE, downlink signaling including an ABR indication for the one or more logical channels.

16. The network entity of claim 15, wherein the one or more processors, to communicate with the UE to signal the information related to the estimated ABR, are configured to:
receive, from the UE, uplink signaling that includes an ABR inquiry for the one or more logical channels, wherein the ABR indication is based at least in part on the ABR inquiry.

17. The network entity of claim 14, wherein the one or more processors, to communicate with the UE to signal the information related to the estimated ABR, are configured to:
receive, from the UE, uplink signaling that includes a preferred rate indication for the one or more logical channels.

18. The network entity of claim 14, wherein the information related to the estimated ABR is signaled in a medium access control (MAC) control element (MAC-CE).

19. The network entity of claim 18, wherein the MAC-CE includes, for each of the one or more logical channels, an identifier of a respective logical channel and a field that indicates whether the MAC-CE is related to the estimated ABR for uplink traffic or downlink traffic associated with the respective logical channel.

20. The network entity of claim 18, wherein the MAC-CE is a downlink MAC-CE transmitted to the UE that includes, for each of the one or more logical channels, an ABR indication that indicates the estimated ABR for a respective logical channel.

21. The network entity of claim 18, wherein the MAC-CE is an uplink MAC-CE received from the UE that includes, for each of the one or more logical channels, a field to indicate whether the uplink MAC-CE carries an inquiry or an indication related to the estimated ABR for a respective logical channel.

22. The network entity of claim 21, wherein the uplink MAC-CE includes, in a field carrying an inquiry related to the estimated ABR for a logical channel among the one or more logical channels, an indicated frame rate to inquire about the estimated ABR for the logical channel at the indicated frame rate.

23. The network entity of claim 21, wherein the uplink MAC-CE indicates, in one or more fields carrying an indication related to the estimated ABR for a logical channel among the one or more logical channels, the frame rate and the bit rate to be used for the traffic associated with the logical channel.

24. The network entity of claim 14, wherein the information related to the estimated ABR is signaled in UE assistance information (UAI) received from the UE.

25. The network entity of claim 24, wherein the UAI indicates that a message carrying the UAI is an inquiry about the estimated ABR for the one or more logical channels, indicates the one or more logical channels associated with the inquiry, and indicates a target frame rate for the one or more logical channels associated with the inquiry.

26. The network entity of claim 24, wherein the UAI indicates that a message carrying the UAI is a rate indication for the one or more logical channels, indicates a new value for one or more of the frame rate or the bit rate to be used for the traffic associated with the one or more logical channels, and indicates when the new value will become effective.

27. A method of wireless communication performed by a user equipment (UE), comprising:
communicating with a network entity to signal information related to an estimated available bit rate (ABR) for each of one or more logical channels on at least one of an uplink or a downlink; and
communicating traffic associated with the one or more logical channels according to a frame rate or a bit rate that is based at least in part on the information related to the estimated ABR for the one or more logical channels.

28. The method of claim 27, wherein the information related to the estimated ABR is signaled in a medium access control (MAC) control element (MAC-CE).

29. The method of claim 27, wherein the information related to the estimated ABR is signaled in UE assistance information (UAI) transmitted to the network entity.

30. A method of wireless communication performed by a network entity, comprising:
communicating with a user equipment (UE) to signal information related to an estimated available bit rate (ABR) for each of one or more logical channels on at least one of an uplink or a downlink; and
communicating traffic associated with the one or more logical channels according to a frame rate or a bit rate that is based at least in part on the information related to the estimated ABR for the one or more logical channels.
